(19) United States
(12) Patent Application Publication
(10) Pub. No.: US 2005/0064334 A1
(43) Pub. Date: Mar. 24, 2005

(54) Information recording medium

(75) Inventors: Akemi Hirotsune, Saitama (JP); Junko Ushiyama, Tokyo (JP); Yumiko Anzai, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(73) Assignee: HITACHI MAXELL, LTD., Osaka (JP)

(21) Appl. No.: 10/929,425

(22) Filed: Aug. 31, 2004

(30) Foreign Application Priority Data
Mar. 18, 2004 (JP) 2004-077408
Sep. 22, 2003 (JP) 2003-329298

(51) Int. Cl. G11B 7/24

(52) U.S. Cl. 430/270.13; 430/945; 428/64.5; 369/275.5; 369/275.2

(57) ABSTRACT

An information recording medium for high-density recording and reproduction that is low-cost and that has good rewrite characteristics. The information recording medium, in which recording is performed as an atomic arrangement is changed by optical irradiation, is capable of a number of rewrites. The information recording medium comprises a substrate on which a first protective layer with a thickness in the range from 18 to 65 nm, a recording film, a second protective layer, and a reflective layer are disposed in the mentioned order as seen from a light-incident side. Not less than 97 atomic % of the composition of the recording film is accounted for by Ge, Bi, and Te.

### CO-PENDING APPLICATION

U.S. patent application No. 10/656,337 is a co-pending application of the present application. The disclosure of this co-pending application is incorporated herein by cross-reference.

### CLAIM OF PRIORITY

The present application claims priority from Japanese application JP 2004-077408 filed on Mar. 18, 2004, and Japanese application JP 2003-329298 filed on Sep. 22, 2003, the contents of which are hereby incorporated by reference into this application.

### BACKGROUND OF THE INVENTION

1. Field of the Invention

The present invention relates to information recording media used for optical discs.

2. Background Art

There are many variations of the principle of recording information on a thin film (recording film) by irradiating it with laser light. Among them, the techniques that utilize a change in atomic arrangement by laser light irradiation, such as a phase-change (also called a phase transition, or a phase transformation) of the film material, are advantageous because they do not involve a deformation of the thin film and therefore allow two disc members to be directly bonded to each other to obtain an information recording medium with a double-sided disc structure.

Information recording media generally consist of a substrate on which a first protective layer, a recording layer of GeSbTe, for example, an upper protective layer, and a reflective layer are mounted. JP Patent Publication (Kokai) No. 2001-266408 A discloses that a first protective layer employs (ZnS)₆₀(SiO₂)₃₀C₁₀, with a film thickness of 50 nm to 400 nm.

In the present specification, the term “phase-change” refers not only to a phase-change between crystal and amorphous states, but also to a phase-change between molten (a change into a liquid state) and re-crystallization states and between crystal states. The term “mark edge recording” refers to a recording method whereby a signal “1” corresponds to an edge portion of a recording mark and a signal “0” corresponds to an area between marks and an area within a mark. In the present specification, the term “optical disc” refers to a disc in which information that can be reproduced by optical irradiation is recorded, and/or an apparatus for reproducing information by optical irradiation.

JP Patent Publication (Kokai) No. 2000-215510 A discloses a GeSbTe recording film including 10% to 40% of Ge, 8% or more of Sb, and 45% to 65% of Te, with a film thickness of more than 14 nm for a single layer, or more than 15 nm and less than 35 nm for a total of two layers.

[Patent Document 1] JP Patent Publication (Kokai) No. 2001-266408 A

[Patent Document 2] JP Patent Publication (Kokai) No. 2000-215510 A

### SUMMARY OF THE INVENTION

In rewritable optical discs, such as DVD-RAMs, a recording track has a preformat portion including an address pit, for example, and a user data portion where recording takes place including a groove for tracking. Recording or reading of information is carried out after confirming the address and detecting clock or synchronizing signals.

In these discs, a first protective layer has a thickness of more than 100 nm, and the preformat portion and the user data portion are subject to different deformations due to stress acting between laminated films and the substrate. As a result, the recording tracks could be bent relative to the preformat portion. In such a case, if a push-pull tracking is performed with respect to a tracking groove, it might be impossible to read the address data in the preformat portion. If a tracking offset is corrected such that accurate positioning is achieved with respect to the preformat portion, the recording region could be offset and, consequently, part of the data in an adjacent track could be erased.

When the first protective layer has a large thickness, as in JP Patent Publication (Kokai) No. 2001-266408 A where the thickness is more than 50 nm, film formation takes time, so that the tact time of sputtering is extended, mass producibility suffers, and material cost increases. To counter these problems, the thickness of the first protective layer could be reduced. However, if the first protective layer is thin, the heat generated in the recording film during a large number of rewrites could be transmitted to the substrate, thereby making the substrate more prone to deterioration. Moreover, contrast could be reduced and jitter could increase.

In a medium such as that disclosed in JP Patent Publication (Kokai) No. 2000-215510 A, a total of the thicknesses of the GeSbTe recording films amounts to from 15 to 35 nm, which is thick. As a result, recrystallization easily occurs. In addition, this prior art employs a process of heating to 75° C. during the formation of the recording film. The heating process takes time, making it impossible to reduce the tact time.

It is therefore an object of the invention to solve these problems of the prior art and provide an information recording medium that can reduce material cost and has excellent mass producibility, and that has a low jitter during a large number of rewrites.

In order to achieve the aforementioned object, the information recording medium according to the invention has adopted the following solutions. Specifically, the thickness of a first protective layer has been reduced to from 18 to 65 nm. A recording film comprises Ge, either Sb or Bi, and Te. The recording film includes from 36.9 to 45.5 atomic % of Ge, from 3.6 to 10.5 atomic % of a total of Bi and Sb, and from 50.9 to 52.6 atomic % of Te. By adopting these ranges, more than 50% modulation can be achieved after 10 rewrites, thus enabling material cost to be reduced and achieving excellent rewriting characteristics at the same time.

Preferably, the first protective layer has a thickness of 18 nm or more but 65 nm or less, and includes not less than 10 mole % of an Mg compound. In this way, more than 50% modulation can be achieved and material cost can be reduced, thereby enabling cost to be reduced and achieving excellent rewrite characteristics at the same time.

The aforementioned composition of the recording film contains much Ge. Ge has thus far been believed unfit for the purpose of rewritable phase-change recording films where a large number of rewrites are carried out, because of its large volume ratio between amorphous and crystal states, and because of its very high melting point, 937° C. The inventors' analysis, however, revealed that there is no performance deterioration even after 100 overwrites in accordance with the present invention.

Preferably, the thickness of the lower protective layer is reduced to 18 nm or more but 65 nm or less, and 97 atomic % or more of the composition of the recording film consists of Ge, Bi, and Te. In this way, material cost can be reduced and excellent rewrite characteristics can be achieved at the same time.

In addition to the word “lower or upper protective layer”, the word “first or second protective layer” is used for the same meaning in this specification.

According to one aspect of the present invention an information recording medium in which a number of rewrites can be performed, wherein a recording is performed by change of atomic arrangement caused by irradiation of light is provided, the information recording medium comprises a substrate on which the following are formed in the mentioned order, as seen from a light-incident side of said substrate:
a first (lower) protective layer with a thickness in the range of 18 nm or more but 65 nm or less and containing a Mg compound of an amount of not less than 10 mole %;
a recording film;
a second (upper) protective layer; and
a reflective layer, wherein
said recording film contains Ge, either Sb or Bi, and Te, wherein the content of Ge is in the range of 36.9 atomic % or more but 45.5 atomic % or less, the content of a sum of Bi and Sb is in the range of 3.6 atomic % or more but 10.5 atomic % or less, and the content of Te is in the range of 50.9 atomic % or more but 52.6 atomic % or less.

Further preferably, the recording film has a thickness of 4 nm or more but 18 nm or less, 97 atomic % or more of the composition of the recording film consists of Ge, Bi, and Te, wherein the content of Ge is in the range of 30 atomic % or more but 50 atomic % or less, the content of Bi is in the range of 2 atomic % or more but 22 atomic % or less, and the content of Te is in the range of 40 atomic % or more but 65 atomic % or less. In this way, better rewrite characteristics can be obtained.

Preferably, the first protective layer is reduced to a thickness of 18 nm or more but 65 nm or less, the recording film has a thickness of 5 nm or more but 13 nm or less, and the composition of the recording film contains 97 atomic % or more Ge, Sb, and Te, wherein the content of Ge is in the range of 37 atomic % or more but 46 atomic % or less, the content of Sb is in the range of 4 atomic % or more but 11 atomic % or less, and the content of Te is in the range of 50 atomic % or more but 53 atomic % or less. In this way, excellent mass producibility and rewrite characteristics can be achieved at the same time.

The basic technology of the recording apparatus (optical disc drive) employing the phase-change recording medium of the invention is as follows.

(One-Beam Overwrite)

A phase-change recording medium is usually rewritten by overwrite (whereby new information is written over old information without erasing the old information beforehand). FIG. 2 shows the principle of overwrite. As the recording film is melted by a high-power laser, the laser-irradiated portion is immediately cooled and is formed into a recording mark of an amorphous state, regardless of whether the previous state is crystalline or amorphous. If the recording film is heated by an intermediate-power laser to temperatures below the melting point where the crystallization rate is high, portions that have previously been amorphous are turned into a crystalline state. Portions that have originally been in a crystalline state remain in the crystalline state. As DVD-RAMs are presumably used for recording moving pictures in many cases, a great amount of information could be recorded in one time. In such cases, it would take twice as much time if recording were to be carried out after all the previous information is erased, possibly requiring a huge amount of buffer memory. Therefore, it is indispensable that there is provided the overwrite capability.

(Mark-Edge Recording)

DVD-RAMs and DVD-RWs adopt a mark edge recording method that allows a high-density recording to be realized. In a mark edge recording, the position of either end of a recording mark formed in the recording film is associated with digital data of 1. In this way, a higher density can be achieved by making the length of a shortest recording mark correspond to two to three reference clocks instead of one. DVD-RAMs adopt a 8-16 modulation method where a shortest recording mark corresponds to three reference clocks. With reference to FIG. 3, as compared with the mark position recording where a center position of a circular recording mark corresponds to digital data of 1, the 8-16 modulation technique has the advantage that a high-density recording can be realized without extremely reducing the size of the recording mark. The recording medium, however, is required to have an extremely small shape-distortion in the recording mark.

(Format)

With reference to FIG. 4 showing the disposition of a header zone at the beginning of each sector, a DVD-RAM has a format such that each track is divided into 24 sectors, allowing for random access recording. DVD-RAMs can therefore be used for a wide range of applications, such as storage devices in personal computers, DVD video cameras and DVD video recorders.

(Land-groove recording)

In DVD-RAMs, as shown in FIG. 5, land-groove recording in which both a tracking groove and a convex portion between grooves are recorded is employed so as to reduce crosstalk. Since land-groove recording utilizes the phenomena in which, when the groove depth is in the vicinity of λ/6n (where λ is the laser wavelength, and n is the refractive index of the substrate) for the contrast (dark/light) recording marks, the recording mark, whether in a land or a groove, in the adjacent track is difficult to be seen. Thus, in a 4.7 GB DVD-RAM, for example, the track pitch can be made as narrow as 0.615 μm. The phase difference between a recording mark and other portions, namely the phase difference component of a reproduction signal, acts in such a manner as to make it more likely for crosstalk to be generated. A design must be adopted, therefore, such that the phase difference can be sufficiently reduced. Since the phase difference component of the reproduction signal is added in a reverse phase to the dark/light reproduction signals of lands and grooves, it can be a cause of imbalance between the land and groove reproduction signal levels.

(ZCLV Recording Method)

In a phase-change recording medium, if the recording waveform is not changed, it is desirable to record at an optimum linear velocity corresponding to the crystallization rate in order to obtain good recording/reproduction characteristics. However, it takes time to change the rotation speed in order to obtain a constant linear velocity when accessing recording tracks on the disc with different radii. In DVD-RAM, therefore, the ZCLV (Zoned Constant Linear Velocity) method is adopted wherein the disc is divided into 24 zones in the radial direction, as shown in FIG. 6. Each zone has a constant rotation speed, and the rotation speed is changed only when another zone must be accessed, so that the access speed does not decrease. In this method, since the linear velocity is slightly different between the innermost track and the outermost track in a particular zone, the recording density is also slightly different. However, the entire region of the disc can be recorded with a substantially maximum density.

(Recording Wavelength)

A recording waveform is related to the shape of a recording mark as follows. For example, in the case of a 4.7 GB DVD-RAM, since a minimum mark length is 0.42 μm and the linear velocity is 8.2 m/s, a recording pulse for forming a single recording mark is divided into a plurality of pulses. For an accurate formation of a recording mark, more emphasis is put on an accurate heating rather than on the prevention of the accumulation of heat. As a result, the recording waveform has little or no portions below an erasing power level, as shown in FIG. 8. Further, as mentioned above, it is also necessary to carry out an adaptive control of the width of the initial and last pulses for forming a recording mark (an adaptive control such that, depending on the length of a space of interest and the length of a previous mark, the position where the last pulse forming the previous mark ends and the position where the initial pulse forming a later mark begins are adjusted).

In summary, the high-performance techniques are:
1. Technique contributing to the narrowing of the track pitch:

Land-groove recording, absorption control, reduction of thickness of first protective layer, and reduction of thickness of reflective layer.
2. Techniques contributing to the narrowing of bit pitch:

Mark-edge recording, ZCLV recording method, absorption control, interface layer, and adaptively controlled recording waveform.
3. Techniques contributing to higher speed:

One-beam overwrite, composition of recording film, absorption control layer, and interface layer.

Thus, each layer has a plurality of functions and the functions of the individual layers are intricately intertwined. The reduction of stress by the reduction of thickness of the first protective layer also contributes to the narrowing of track pitch by preventing groove deformation. Thus, it is extremely important to optimize the combination of layered films and their film thickness for achieving higher performance.

As described above, in accordance with the invention, information recording media for high-density recording and reproduction can be obtained in which the films can be formed using the 7-chamber manufacturing equipment and that is superior in terms of material cost, rewrite characteristics, and mass producibility.

### BRIEF DESCRIPTION OF THE DRAWINGS

FIG. 1 shows a cross section of an example of the information recording medium according to the invention.

FIG. 2 illustrates the principle of overwrite.

FIG. 3 shows a mark position recording and a mark edge recording.

FIG. 4 shows a header portion of a format on a substrate.

FIG. 5 shows a format of a substrate.

FIG. 6 shows the arrangement of a format on a substrate.

FIG. 7 shows a recrystallization area in a recording film.

FIG. 8 shows a relationship between an adaptive control of a recording waveform and mark lengths.

FIG. 9 shows a cross section of an example of an information recording medium according to prior art.

FIG. 10 shows a relationship between material cost of the invention and that of prior art.

FIG. 11 shows a relationship between the number of overwrites and the thickness of a first protective layer in the present invention and prior art.

FIG. 12 shows composition ranges in which good rewrite characteristics can be obtained in Embodiment 7.

FIG. 13 shows relationships among the content of Ge, the thickness of a recording film and cross-erase jitter in Embodiment 7 of the invention.

FIG. 14 shows relationships among the content of Te, the thickness of a recording film and cross-erase jitter in Embodiment 7 of the invention.

FIG. 15 shows relationships among the content of Bi, the thickness of a lower protective layer and cross-erase jitter in Embodiment 7 of the invention.

FIG. 16 shows composition ranges in which good rewrite characteristics can be obtained in Embodiment 8 of the invention.

FIG. 17 shows relationships among the content of Ge, the thickness of a recording film and cross-erase jitter in Embodiment 8 of the invention.

FIG. 18 shows relationships among the content of Te, the thickness of a recording film and cross-erase jitter in Embodiment 8 of the invention.

FIG. 19 shows relationships among the content of Sb, the thickness of a lower protective layer and cross-erase jitter in Embodiment 7 of the invention.

### DESCRIPTION OF THE PREFERRED EMBODIMENTS

### Embodiment 1

(Structure and Process of Manufacturing the Information Recoding Medium of the Invention)

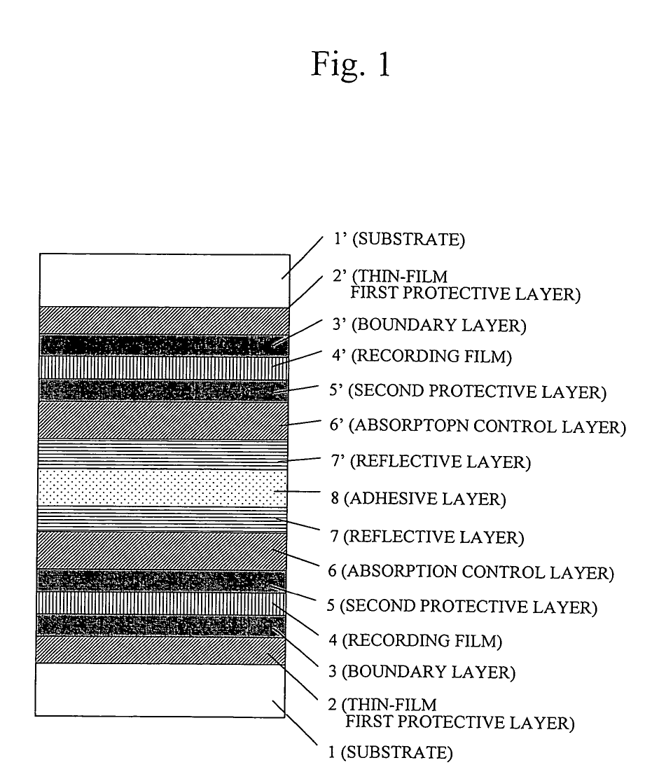

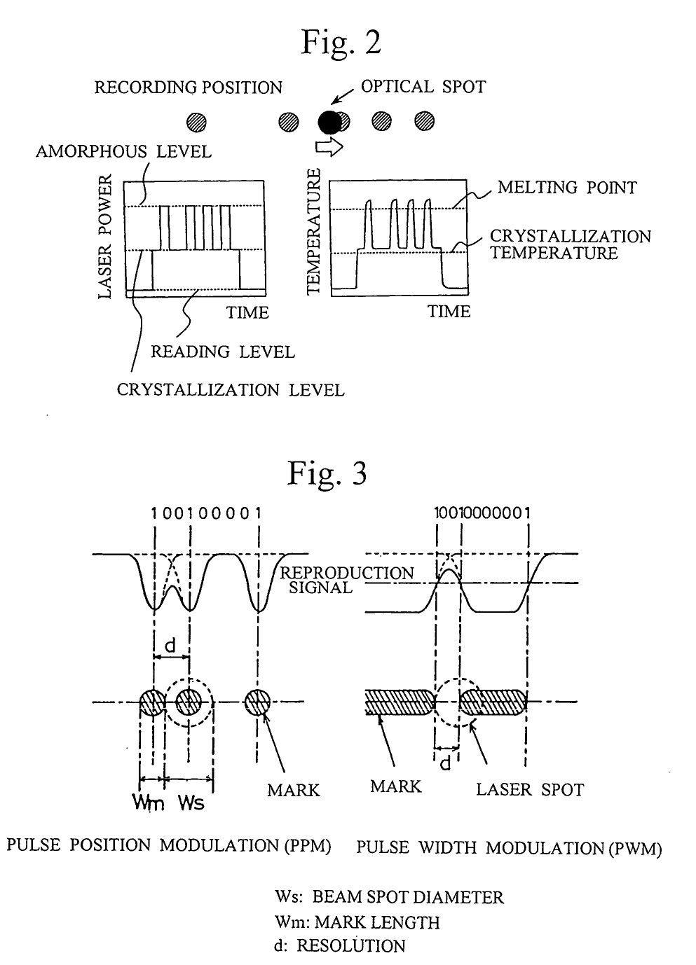

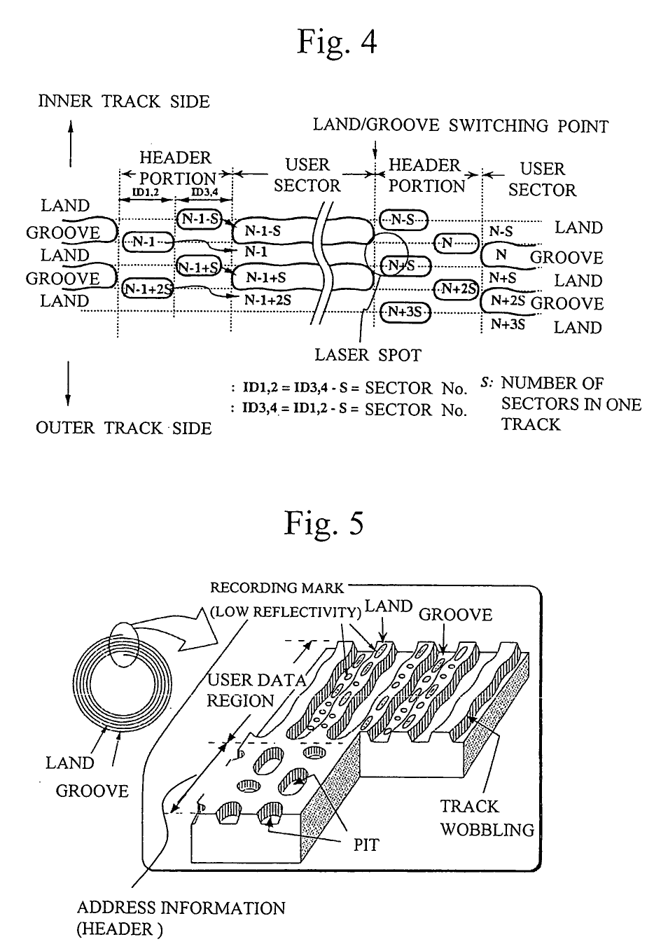

FIG. 1 is a cross section of the disc information recording medium according to a first embodiment of the invention, which was manufactured by the following process.

First, a first protective layer 2 comprising (MgF₂)₅₀(ZnS)₅₀ was formed on a polycarbonate substrate 1 of a diameter 12 cm and a thickness 0.6 mm, to a film thickness of 30 nm. The substrate 1 was provided on the surface thereof tracking grooves of a track pitch of 0.615 microns for land/groove recording, and with a pit sequence at a position off the track center, i.e., substantially on an extension of the boundary between land and groove, the pit sequence indicating address information or the like. Then, a lower boundary layer 3 comprising a Cr₂O₃ film was formed to a thickness of 2 nm, followed by the sequential formation of a recording film 4 comprising Ge_{38.1}Sb_{9.5}Te_{52.4}, a second protective layer 5 with a thickness of 8 nm and comprising SnO₂ to a thickness of 33 nm, an absorption control layer 6 comprising Cr₉₀(Cr₂O₃)₁₀ to a thickness of 34 nm, and a reflective layer 7 comprising Al₉₉Ti₁ to a thickness of 60 nm. In the present example, compounds whose Cr to oxygen ratio is somewhat different from 2:3 and compounds whose Si to oxygen ratio is somewhat different from 1:2 are also referred to as Cr₂O₃ and SiO₂, respectively. By “somewhat different” herein is meant the tolerance of ±20%. Thus, the compounds that are “somewhat” off the 2:3 ratio, for example, include those compounds within the range of 2:2.4 to 3:6.

Thus, the information recording medium of the invention is made up of not more than six layers stacked upon each other, so that the film formation can be performed by manufacturing equipment with a six-chamber sputtering apparatus.

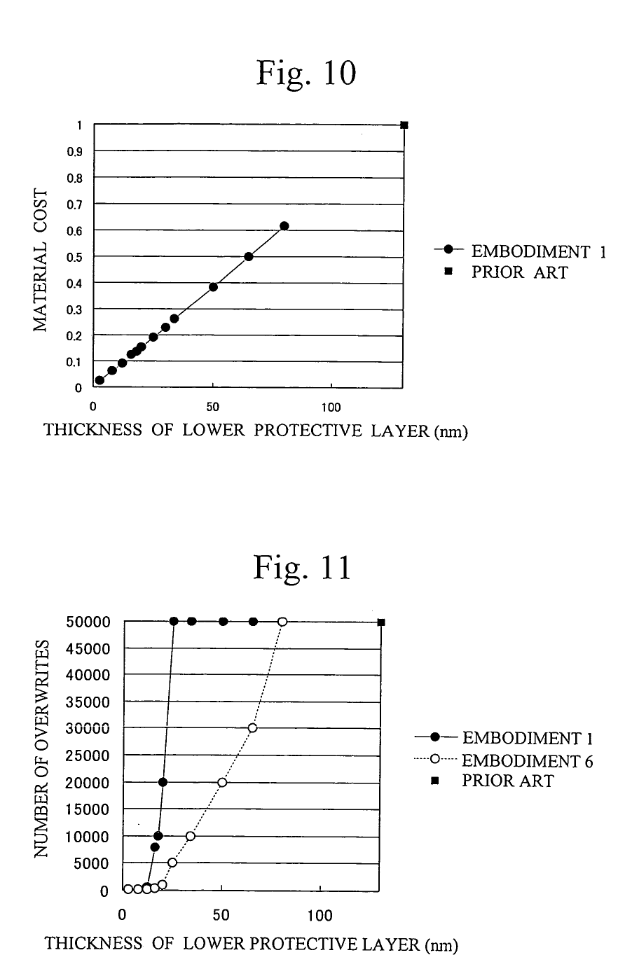

Since the entire film thickness is less than 160 nm, the information recording medium has superior mass-producibility. As shown in FIG. 10 and Table 1, because of the reduced thickness of the first protective layer, material cost can be reduced as compared with a 130 nm conventional disc (Comparative Example 1). In Table 1, the material cost is shown as ratios to the thickness 130 nm taken as one.

TABLE 1

| First protective layer | |
|---|---|
| thickness (nm) | Material cost |
| 3 | 0.02 |
| 8 | 0.06 |
| 12 | 0.09 |
| 16 | 0.12 |
| 18 | 0.14 |
| 20 | 0.15 |
| 25 | 0.19 |
| 34 | 0.23 |
| 50 | 0.38 |
| 65 | 0.50 |
| 80 | 0.62 |

Thus, when the thickness is not more than 65 nm, material cost can be reduced to ½.

Composition ratios are expressed in terms of atomic % or mole %. The film formation was carried out in a magnetron sputtering apparatus using Ar gas. A first disc member was thus obtained.

A second disc member with exactly the same composition as the first disc member was obtained in the identical manner. The film surface of the first and second disc members was then coated with a protection coating 22 of UV-curing resin, and the individual UV-curing resin layers were then bonded to each other via an adhesive layer, thereby obtaining the disc information recording medium shown in FIG. 1. Instead of the second disc member, a protection substrate may be used.

(Initial Crystallization Method)

The initial crystallization was performed in the recording film of the disc manufactured as described above, in the following manner. The disc was rotated such that the linear velocity of a spot on the recording track was 6 m/s, and then the recording film 4 was irradiated, via the substrate 1, with semiconductor laser (wavelength approx. 810 nm) having an elliptical spot shape that is longer in the radius direction of the medium, and with laser light power of 600 mW. The spot was moved ¼ of the spot length at a time in the radius direction of the medium. In this way, initial crystallization was performed. When the initial crystallization was repeated once, increase in noise due to initial crystallization was slightly reduced.

(Recording, Erasing, and Reproduction)

Recording and reproduction of information was performed on the above-described information recording medium using an information recording/reproduction evaluation device. The operation of the information recording/reproduction evaluation device will be described below. As the motor control method during a recording or reproduction, the ZCAV (Zoned Constant Linear Velocity) method was adopted whereby the rotation speed of the disc is varied for each zone in which the recording or reproduction takes place. The disc linear velocity was about 8.2 m/s.

For the recording of information in the disc, the so-called 8-16 modulation method was employed whereby 8 bits of information are converted into 16 bits. Information from the outside of the recording apparatus is sent to an 8-16 modulator in units of 8 bits. In this modulation method, information is recorded on the medium as recording mark lengths of 3 T to 14 T corresponding to the 8-bit information. T herein refers to the period of the clock during the recording of information. The period was 17.1 ns in the present example. Digital signals of 3 T to 14 T converted by the 8-16 modulator are transferred to a recording wavelength generating circuit. In the recording wavelength generating circuit, the signals of 3 T to 14 T are made to correspond to “0” and “1” alternately along the time axis, such that for the case of “0”, laser of immediate laser power is irradiated, while for the case of “1”, a high-power pulse or pulse train is irradiated. The width of the high-power pulse was set to approximately 3 T/2 to T/2. When forming a recording mark of 4 T or longer, a multi-pulse recording waveform is generated using a pulse train consisting of a plurality of high-power pulses, such that between the pulses of a pulse train, laser irradiation of low-power level with a width of approximately T/2 is performed, and at portions between pulse trains where no recording mark is formed, laser irradiation of an intermediate power level is performed.

The high power level for forming a recording mark was set to 11 mW, the intermediate power level capable of erasing a recording mark was set to 5 mW, and the low power level that is lower than the intermediate power level was set to 5 mW. The low power level may be thus equal to the intermediate power level, or they may be different. An area on the optical disc that is irradiated with an intermediate-power laser beam becomes crystalline (space), and an area irradiated with a high-power level pulse train turns into an amorphous recording mark. The recording waveform generating circuit includes a multi-pulse waveform table adapted for the method (adaptive recording waveform control) whereby, when forming a series of high-power pulse train for forming a mark portion, the pulse width at the head and that at the tail of a multi-pulse waveform are varied depending on the length of the space in front of and behind the mark. Consequently, a multi-pulse recording waveform is formed that can greatly eliminate the influence of inter-mark thermal interference generated between marks. The recording medium has a higher reflectivity in a crystalline state, and the regions that have been recorded and turned into an amorphous state have lower reflectivity. The recording waveform generated by the recording waveform generating circuit is transferred to a laser drive circuit, which then varies the output power of the semiconductor laser in the optical head based on the waveform. Information is recorded by the optical head of the recording apparatus using a laser beam of a wavelength of 660 nm as the energy beam for information recording.

When a mark-edge recoding is performed under the above-described conditions, the mark length of a 3 T mark, which is the shortest mark, is approximately 0.42 μm, and the mark length of a 14 T mark, which is the longest mark, is approximately 1.96 μm. A recording signal includes dummy data of repeat 4 T marks and 4 T spaces at the start and end of the information signal. The start portion also includes VFO.

In this recording method, new information can be recorded by writing it over the area where information is already recorded without erasing it. Namely, overwrite can be performed using a single, substantially circular optical spot.

The present recording apparatus is adapted for the method (so-called land-groove (L/G) recording method) whereby information is recorded in both grooves and lands (regions between grooves). In the present recording apparatus, tracking of a land or a groove can be arbitrarily selected by an L/G servo circuit.

Reproduction of the recorded information was also performed using the above-mentioned optical head. A reproduction signal was obtained by irradiating a 1 mW laser beam onto a recording track and detecting reflected light from marks and regions other than marks. The amplitude of the reproduction signal is amplified by a preamp circuit and then converted by an 8-16 demodulator into 8-bit information for each 16 bits. By the above operation, the reproduction of the recorded information is completed.

(Evaluation of the Rewrite Characteristics)

In the disc of Embodiment 1, a recording pattern randomly including 3 T to 11 T (a random pattern) was recorded, and then the modulation after 10 overwrites was determined. The modulation was 52% for lands and 60% for grooves, which are both more than 50% and good. The jitter after 10 overwrites exhibited a good value of 6.7%. The jitter is shown in values obtained by dividing an average value of lands and grooves by the clock period T.

Then, the number of overwrites where the jitter is not more than 13% was determined. In the case of the disc according to the present embodiment, as many as 10,000 overwrites can be performed in cases where the thickness of the first protective layer is not less than 18 nm, as shown in FIG. 11 and Table 2.

TABLE 2

| First protective layer | Number of overwrites |
|---|---|
| thickness (nm) | where the jitter is 13% |
| 3 | 200 |
| 8 | 200 |
| 12 | 550 |
| 16 | 8000 |
| 18 | 10000 |
| 20 | 20000 |
| 25 | 50000 or more |
| 34 | 50000 or more |
| 50 | 50000 or more |
| 65 | 50000 or more |
| 80 | 50000 or more |

(Composition of the Recording Film)

In the disc of Embodiment 1, a recoding pattern including 3 T to 11 T randomly (random pattern) was recorded, and the jitter after 10 overwrites was determined. The jitter after 10 overwrites exhibited a good value of 6.7% in terms of an average of lands and grooves. The jitter is shown in values obtained by dividing an average value of lands and grooves by the clock period T.

Table 3 shows the result of examining the jitter as the composition of the recording film was changed.

TABLE 3

| Composition of recording | Jitter after 10 |
|---|---|
| film (atomic %) | overwrites (%) |
| Ge_{33.3}Sb_{13.3}Te_{53.3} | 10.6 |
| Ge_{35.3}Sb_{11.8}Te_{52.9} | 9.0 |
| Ge_{36.9}Sb_{10.5}Te_{52.6} | 7.0 |
| Ge_{38.1}Sb_{9.5}Te_{52.4} | 6.7 |
| Ge_{39.1}Sb_{8.7}Te_{52.2} | 6.8 |
| Ge_{40.0}Sb_{8.0}Te_{52.0} | 7.1 |
| Ge_{41.4}Sb_{6.9}Te_{51.7} | 7.5 |
| Ge_{42.4}Sb_{6.1}Te_{51.5} | 7.8 |
| Ge_{43.2}Sb_{5.4}Te_{51.4} | 8.0 |
| Ge_{44.5}Sb_{4.4}Te_{51.1} | 8.3 |
| Ge_{45.5}Sb_{3.6}Te_{50.9} | 9.0 |
| Ge_{46.6}Sb_{2.7}Te_{50.7} | 10.2 |

It is seen from the above that good rewrite characteristics were obtained with the jitter not exceeding 9% when Ge was from 36.9 to 45.5 atomic %, Sb was from 3.6 to 10.5 atomic %, and Te was from 50.9 to 52.6 atomic %. This is due to the fact that, although the contrast is low in the case of a medium with a thin first protective layer, the use of the Ge—Sb—Te material in the above-mentioned compositions allows optical properties, such as a large contrast between a crystalline state and an amorphous state in the recording film material, to be satisfied such that the contrast increases and the erasure ratio also increases, making it possible to reduce the jitter during rewrite.

Further, better rewrite characteristics were obtained with the jitter not exceeding 8% when the content of Ge was from 36.9 to 43.2 atomic %, the content of Sb was from 5.4 to 10.5 atomic %, and the content of Te was from 51.4 to 52.6 atomic %.

In addition, particularly good rewrite characteristics were obtained with the jitter not exceeding 7% when the content of Ge was from 36.9 to 39.1 atomic %, the content of Sb was from 8.7 to 10.5 atomic %, and the content of Te was from 52.2 to 52.6 atomic %.

(Composition and Film Thickness of the First Protective Layer)

The change in reflectivity after 10,000 rewrites was determined by changing the mole ratio of MgF₂ and ZnS in the material of the first protective layer. As the film formation rate varies depending on the amount of MgF₂, the ratio with (ZnS)₈₀ (SiO₂)₂₀ was determined, and the results are shown in Table 4.

TABLE 4

| MgF₂ content | Change in | Rate of film |
|---|---|---|
| (mole %) | reflectivity (mV) | formation |
| 6 | 20 | 2.5 |
| 10 | 10 | 2.0 |
| 15 | 8 | 1.7 |
| 25 | 6 | 1.5 |
| 40 | 3 | 1.2 |
| 60 | 2 | 1.0 |
| 75 | 1 | 0.9 |
| 90 | 0 | 0.7 |
| 100 | 0 | 0.2 |

It is seen that in cases where the amount of MgF₂ was from 10 to 90 mole %, good overwrite characteristics were obtained with a change in reflectivity of not more than 10 mV, and the film formation rate was also good at not less than 0.7. In cases where the amount of MgF₂ was from 20 to 75 mole %, good rewrite characteristics were obtained with a change in reflectivity of not more than 6 mV and with a film formation rate of one or higher. These results are due to the fact that, as the MgF₂—ZnS material was used in the above compositions, there were obtained the property that the change in reflectivity due to recording film flow or substrate deformation upon 10000 rewrites can be prevented by the hardness of the Mg compound, and the property that the ZnS material has a high film formation rate.

The same rewrite characteristics and film formation characteristics were obtained when MgF₂ in the first protective layer was replaced by another Mg compound, such as MgO. MgF₂ is preferable as it has a smaller reflectivity n than MgO, so that the contrast can be increased by 1.05 times. On the other hand, MgO is preferable as it can reduce material cost to 60% that in the case of MgF₂.

The same rewrite characteristics and film formation characteristics were obtained when part of ZnS in the first protective layer was replaced by SnO₂, Ta₂O₅, In₂O₃, or a mixture thereof.

The material containing In₂O₃ is more preferable as it has a low target electric resistance, which enables a DC sputtering and helps achieve a shorter tact time. When the material contained ZnS, the material cost was reduced to approximately 80% that in the cases of SnO₂, Ta₂O₅, and In₂O₃, thereby enabling the target preparation cost to be reduced. In the case where the material contains SnO₂, better adhesion with the boundary layer or the substrate was obtained. Furthermore, in this case, the result of an accelerated test at 90° C. and humidity of 80% showed that the storage life was more than twice as long as that of ZnS, Ta₂O₅, or In₂O₃, and that there was no peeling of the film. The material containing Ta₂O₃ is so hard that it was capable of reducing the change in reflectivity after more than 10000 rewrites to 80% as compared to the cases of SnO₂, ZnS, and In₂O₃.

A large effect of reducing the change in reflectivity was also obtained when ZnS in the first protective layer was replaced by Cr₂O₃, Al₂O₃, SiO₂, or a mixture thereof, such that the change in reflectivity was halved as compared with the case of SnO₂. The film formation rate was also halved as compared with the case of SnO₂. When the layer contained Cr₂O₃, among others, good adhesion with the boundary layer or the substrate was obtained. The result of an accelerated test at 90° C. and humidity of 80% showed that the storage life was more than three times as long as that in the cases of Al₂O₃ or SiO₂, and that there was no peeling of the film. When the layer contains Al₂O₃, a smaller absorption coefficient k can be obtained and the contrast can be improved by 1.05 times as compared with the case of Cr₂O₃. When the layer contained SiO₂, the material cost was reduced to approximately 60% that in the case of Cr₂O₃ or Al₂O₃, thereby enabling the target manufacturing cost to be reduced.

When impurity elements are 5 atomic % or more with respect to the elements making up the first protective layer, the contrast decreases and jitter increases by more than 1%. Therefore, impurity elements are preferably less than 5 atomic % or, more preferably, less than 3 atomic %.

(Composition and Film Thickness of the Recording Film)

When the content of any of the constituent elements of the recording film was changed from the above compositions by 3 atomic % or more, the crystallization speed was either so fast that recrystallization took place during cooling after the melting of the recording film for recording, resulting in the deformation of the recording mark, or so slow that some portions remained un-erased, for example. Thus, impurity elements should preferably be less than 3 atomic % or, more preferably, less than 1 atomic %.

If the thickness of the recording layer is too thin, there would not be sufficient formation of crystal nuclei during erasure. In addition, the contrast and the intensity of a reproduction signal would decrease in the case of a disc with a thin first protective layer. As a result, the jitter in the reproduction signal would exceed an allowable range. Thus, the thickness of the recording film should preferably be not less than 5 nm. If the thickness of the recording film is too thick, such as more than 13 nm, the recrystallization region would extend so much that the jitter would exceed 13% after overwrites of 10 times. Thus, the thickness of the recording film should preferably be less than 13 nm.

(Composition and Film Thickness of the Boundary Layer)

Cr₂O₃ in the boundary layer has the effect of preventing the diffusion of protective layer material components into the recording film, and improving the crystallization rate, thereby increasing the number of times of possible rewrites, together with the first protective layer.

This composition of the boundary layer provides the advantage that the film can be formed with an atmospheric gas consisting only of Ar, and that it has a good adhesion property with the other layers. Cr₂O₃ may be replaced by a Ta—O material, or a nitride such as a Ge—Cr—N material with a composition of Ge₅₀Cr₁₀N₄₀, for example, where Ge or Si is from 30 to 60 atomic %, and Cr is from 5 to 20 atomic %, a Si—Cr—N material, a Ge—Si—Cr—N material, a Ti—N material such as Sn₇₀N₃₀, a Ta—N material such as Ta₅₅N₄₅, or a Sn—N material such as Ti₆₀N₄₀. In this way, the crystallization rate can be increased, but the number of times of possible rewrites decreases by 20 to 30%. If part of Cr₂O₃ is replaced by any of the above-mentioned materials, the decrease in the number of possible rewrites would be less severe as compared with the case of entirely replacing Cr₂O₃, but the crystallization rate increasing effect would also suffer.

When the linear velocity is not more than 10 m/s, a Sn oxide such as SnO₂ presents no problems in terms of crystallization rate of the recording film and is preferable in that the film formation rate is three times as high as that in the case of Cr₂O₃. However, the number of times of possible rewrites decreases by 20%. Alternatively, a Sn—O—N material may be used. As the heat conductivity of the materials containing Sn is relatively low, it was possible to combine the boundary layer and the protective layer into a single layer that provides the both functions. In particular, if an oxide or nitride of Cr and Ge is contained in not less than 60 mol %, the storage life can be increased and a high performance can be maintained even when placed in a high-temperature and high-humidity environment. Further, the compositions containing Ge, such as GeN and GeO, are preferable as they have a faster sputter rate during film formation such that the tact time during manufacture can be reduced. However, the material cost would be relatively expensive.

Less preferable compositions include SiO₂, Al₂O₃, Ta₂O₅, a mixture of Ta₂O₅ and Cr₂O₃, and a mixture of Cr—N, Ge—N, and Ge—O. Further less preferable compositions include ZnO₂, ZrO₂, Y₂O₃, and a mixture of Cr₂O₃ or Cr—N, Ge—N and Ta₂O₅. CoO, Cr₂O, and NiO are more preferable as they produce a uniform crystal particle size upon initial crystallization such that an increase in jitter in an initial phase of rewriting can be reduced. Also more preferable are nitrides such as AlN, BN, CrN, Cr₂N, GeN, HfN, Si₃N₄, an Al—Si—N material (such as AlSiN₂), a Si—N material, a Si—O—N material, TaN, TiN, and ZrN, as they increase the adhesive power, so that the deterioration of the information recording medium due to external shock can be reduced.

When the film thickness of the boundary layer is not less than 1 nm, the boundary layer provides the effect of preventing the adverse effect of the protective layer material, such as ZnS, diffusing into the recording film after a number of overwrites, as well as improving the adhesive property. In order to obtain the crystallization rate improving effect sufficiently, the film thickness should preferably be 2 nm or more. However, when the thickness is not less than 3 nm in the case of a Cr₂O₃ boundary layer on the light-incident side, problems arise that, for example, the reflectivity decreases due to the absorption of light by this layer. Desirably, therefore, the thickness should not be more than 5 nm. Nevertheless, the thickness may be somewhat thicker, such as 7 nm, from the viewpoint of balancing the upper and lower thermal diffusion. More preferably, the thickness is not more than 10 nm.

Thus, the thickness of the boundary layer on the light-incident side should be from 1 to 8 nm. In the case where the protective layer adjacent the boundary layer is an oxide or a nitride, the boundary layer is used for the purpose of improving adhesion property, as the protective layer has the crystallization rate improving effect. Therefore, in cases where not less than 40 mole % of the first protective layer consists of an oxide or an oxide/nitride and a nitride, the thickness of the boundary layer on the light-incident side should preferably be from 1 to 3 nm.

In the case of a boundary layer of Ge—Cr—N, for example, where the absorption rate is lower than that in the case of Cr₂O₃, no problems arose when the thickness was increased. However, since boundary layer materials have a low sputter rate, the thickness should preferably be 20 nm from the viewpoint of productivity.

When there is not less than 5 atomic % of impurity elements with respect to the boundary-layer constituent elements, the crystallization rate drops and the increase in jitter during overwrite becomes 1% or more. Thus, the impurity elements should preferably be less than 5 atomic % or, more preferably, less than 3 atomic %.

(Composition and Film Thickness of the Reflective Layer)

In order to adjust the absorption ratio and maintain a high contrast, the reflective layer employs Cr, Al, In, Ni, Mo, Pt, Pd, Ti, W, Ge, Sb, Bi, or an alloy or compound containing any of these elements. The content of these elements in the alloy or compound should preferably be not less than 50 atomic %. This layer absorbs light to an appropriate extent and transmits light to an appropriate extent. As a result, the light that passed through the recording film at a recording mark with a low reflectivity is reflected by the reflective layer and then absorbed by the recording layer again, thus preventing the temperature from rising too much and making Ac/Aa 1 or more. Using at least one of the elements Au, Ag, Cu, and Al in the alloy in order to adjust thermal dissipation was also effective in improving the quality of the reproduction signal.

In a high-density phase-change optical disc, the track pitch is so narrow that consideration must be given to the phenomena called cross-erase in which part of a recording mark that is already written in an adjacent track is erased. In order to prevent cross-erase, the above-mentioned thermal dissipation in the longitudinal direction is important, because, for one thing, the dissipation in the vertical direction makes it difficult for the heat to go in the direction of the track. If Ac/Aa is more than 1, there would be less temperature increase in the recording mark in the adjacent track, thereby helping to prevent cross-erase.

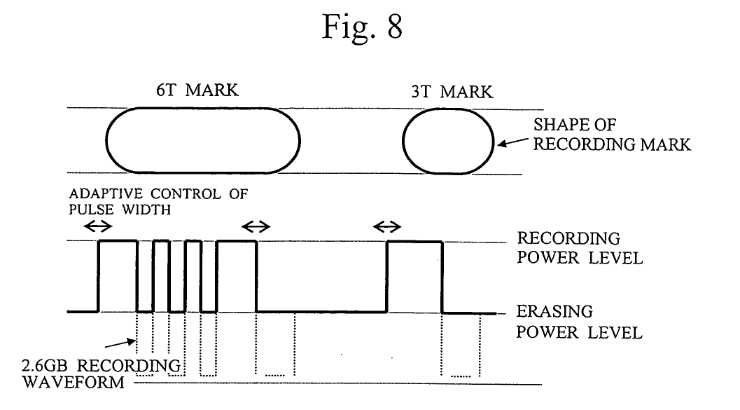

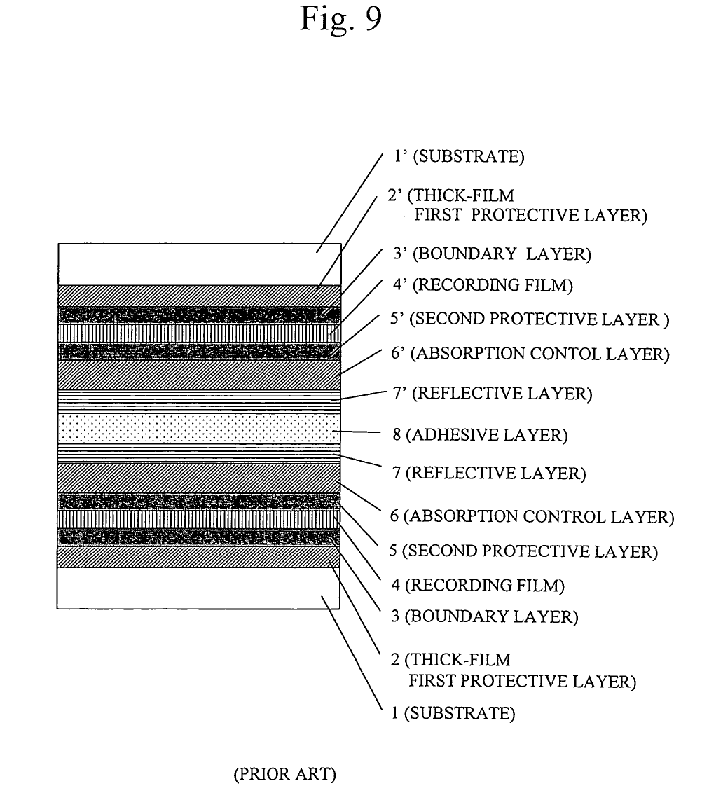

In order to prevent cross-erase, it is also important to prevent recrystallization. This is due to the fact that, as shown in FIG. 8, if a portion that remains as an amorphous recording mark due to recrystallization from the peripheral areas after the melting of the recording film upon recording narrows, it would be necessary to melt a large region in order to form a recording mark with a predetermined size and that would tend to increase the temperature in the adjacent track. If the heat can be dissipated in the longitudinal direction, recrystallization can be prevented. This is due to the fact that as the heat at the central portion is dissipated in a lateral direction during the formation of the recording mark such that the cooling of the peripheral regions of the melted region is slowed, thereby helping to prevent recrystallization.

Preferable materials for the reflective layer include Cr, Cr—Al, Cr—Ag, Cr—Au, Cr—Ge, Cr—Ti, and a material that contains, as a principal component, Cr or a Cr alloy. Less preferable materials include a material that contains, as a principal component, an Al alloy such as Al—Ti, Al—Cr, or Al—In, and Ge—Cr, Ge—Si, or Ge—N. Other materials that can be used include material that contains, as a principal component, Co, Ni, Mo, Pt, W, Ge, Sb, Bi, Ag, Au, or Cu.

By setting the content of elements other than Cr, for example, in the range of from 0.5 to 20 atomic %, the rewrite characteristics during a number of rewrites and the bit-error rate were improved, and they were even more improved when the range was set between 1 and 10 atomic %. When less than 20 atomic % oxygen (O) was added in Cr, the peeling of films was made less likely to occur, which is desirable. The same effect was obtained by adding Ti.

By setting the content of elements other than Al, for example, in the range between 3 and 20 atomic %, the rewrite characteristics during a number of rewrites and the bit-error rate were improved, and they were even more improved when the range was set between 5 and 15 atomic %.

By setting the content of elements other than Ge, for example, in the range between 0 and 80 atomic %, the rewrite characteristics during a number of rewrites and the bit-error rate were improved, and they were even more improved when the range was set between 2 and 50 atomic %.

Other examples of the materials for the reflective layer include those containing, as a principal component, an Ag alloy such as Ag—Pd, Ag—Cr, Ag—Ti, Ag—Pt, Ag—Cu, and Ag—Pd—Cu. Less preferable examples include those that contain, as a principal component, an Au alloy such as Au—Cr, Au—Ti, Au—Ag, Au—Cu, and Au—Nd, and a Cu alloy. While these examples can provide high reflectivity and good reproduction characteristics, Pt and Au are precious metals and are therefore expensive, such that they might lead to an increased cost as compared with Cr, Al, Co, Ni, Mo, Ag, W, Ge, Sb, or Bi.

If impurity elements are contained in not less than 5 atomic % relative to the reflective-layer constituting elements, the heat conductivity decreases and the jitter during a number of rewrites increases. Thus, the impurity elements should preferably be less than 5 atomic % or, more preferably, less than 3 atomic %.

Thus, the thickness of the reflective layer should preferably be from 10 to 70 nm. If the thickness is too small, the modulation decreases and there would be insufficient cooling of the heat, thereby increasing the jitter during a number of rewrites. If, on the other hand, the film is too thick, the absorption ratio would decrease and the jitter during overwrite would increase, as well as contributing to the deformation of the grooves due to stress in the substrate.

(Composition and Film Thickness of the Second Protective Layer)

The materials for the second protective layer include: Sn—O or Sn—O—N materials, such as SnO₂; Sn—Si—O, Sn-Si—N, or Sn—Si—O—N materials, such as SnO₂—SiO₂, SnO₂—Si₃N₄, and SnO₂—SiO₂—Si₃N₄; Sn—Al—O, Sn—Al—N, or Sn—Al—O—N materials such as SnO₂—Al₂O₃, SnO₂—AlN, and SnO₂—Al₂O₃—AlN; Sn—Cr—O, Sn—Cr—N, or Sn—Cr—O—N materials such as SnO₂—Cr₂O₃, and SnO₂—CrN, SnO₂—Cr₂O₃—CrN; Sn—Mn—O, Sn—Mn—N, or Sn—Mn—O—N materials such as SnO₂—Mn₃O₄, SnO₂—Mn₅N₂, and SnO₂—Mn₃O₄—Mn₅N₂; Sn—Ta—O, Sn—Ta—N, or Sn—Ta—O—N materials, such as SnO₂—Ta₂O₅, SnO₂—Ta₂N, and SnO₂—Ta₂O₅—Ta₂N; Sn—Ge—O, Sn—Ge—N, or Sn—Ge—O—N materials such as SnO₂—GeO₂, SnO₂—Ge₃N₄, and SnO₂—GeO₂—Ge₃N₄; Sn—Ti—O, Sn—Ti—N, or Sn—Ti—O—N materials such as SnO₂—TiO₂, SnO₂—Ti₂N, and SnO₂—TiO₂—Ti₂N; Sn—Mo—O, Sn—Mo—N, or Sn—Mo—O—N materials such as SnO₂—MoO₃, SnO₂—Mo₂N—MoN, and SnO₂—MoO₂—Mo₂N—MoN; Sn—Zr—O, Sn—Zr—N, or Sn—Zr—O—N materials such as SnO₂—ZrO₂, SnO₂—ZrN, and SnO₂—ZrO₂—ZrN; Sn—Co—O, Sn—Co—N, or Sn—Co—O—N materials such as SnO₂—Co₂O₃, SnO₂—Co₂N, and SnO₂—Co₂O₃—Co₂N; Sn—In—O, Sn—In—N, or Sn—In—O—N materials such as SnO₂—In₂O₃, SnO₂—In—N, and SnO₂—In₂O₃—N; Sn—Zn—O, Sn—Zn—N, or Sn—Zn—O—N materials such as SnO₂—ZnO, SnO₂—Zn—N, and SnO₂—ZnO—Zn—N; Sn—Gd—O, Sn—Gd—N, or Sn—Gd—O—N materials such as SnO₂—Gd₂O₃, SnO₂—Gd₂N, and SnO₂—Gd₂O₃—Gd₂N; Sn—Bi—O, Sn—Bi—N, or Sn—Bi—O—N materials such as SnO₂—Bi₂O₃, SnO₂—Bi—N, and SnO₂—Bi₂O₃—Bi—N; Sn—Ni—O, Sn—Ni—N, or Sn—Ni—O—N materials such as SnO₂—Ni₂O₃, SnO₂—Ni—N, and SnO₂—Ni₂O₃—Ni—N; Sn—Nb—O, Sn—Nb—N, or Sn—Nb—O—N materials such as SnO₂—Nb₂O₃, SnO₂—NbN, and SnO₂—Nb₂O₃—NbN; Sn—Nd—O, Sn—Nd—N, or Sn—Nd—O—N materials such as SnO₂—Nd₂O₃, SnO₂—NdN, and SnO₂—Nd₂O₃—NdN; Sn—V—O, Sn—V—N, or Sn—V—O—N materials such as SnO₂—V₂O₃, SnO₂—VN, and SnO₂—V₂O₃—VN; and mixtures thereof, such as Sn—Cr—Si—O—N materials, Sn—Al—Si—O—N materials, and Sn—Cr—Co—O—N materials.

Of the above-mentioned compositions, Sn—O or Sn—O—N materials were more preferable in that their film formation rate was approximately twice as high as that of the conventional materials (ZnS)₈₀(SiO₂)₂₀, and were therefore suitable for mass production. When the Sn—O or Sn—O—N material in the mixture material was not less than 70 mol % of the entirety, the film formation rate was approximately 1.5 times as high as that of (ZnS)80(SiO₂)₂₀. When the Cr—O or Cr—O—N material in the mixture material was not less than 70 mol % of the entirety, better thermal stability was obtained and the deterioration of the erasure ratio during rewrite was less likely to occur than in the case of Sn—O or Sn—O—N material. The same effect was observed when Mn—O or Mn—O—N was used instead of the Cr—O or Cr—O—N material.

A high stability can be obtained also in materials such as Sn—Gd—O, Sn—Gd—N, or Sn—Gd—O—N materials, Sn—Bi—O, Sn—Bi—N, or Sn—Bi—O—N materials, Sn—Zr—O, Sn—Zr—N, or Sn—Zr—O—N materials. However, their sputter rates are lower than those of Sn—Cr—O, Sn—Cr—O—N, Sn—Mo—O, or Sn—Mn—O—N by approximately 10 %. When the Sn—Ge—O, Sn—Ge—N, or Sn—Ge—O—N material was used, the adhesive power with the recording film increased, such that the storage life improved. The same effect was obtained when Sn—Mo—O or Sn—Mo—O—N material was used instead of the Sn—Ge—O, Sn—Ge—N, or Sn—Ge—O—N material.

Sn—In—O, Sn—In—N, or Sn—In—O—N material has the advantage that electric resistance is low and a DC sputtering can be performed. While it is possible to increase the sputter rate more than twofold when the amount of In is greater than Sn, this would lead to a change in reflectivity after rewrites of more than 500 times. Sn—Zn—O, Sn—Zn—N, or Sn—Zn—O—N material could also be subjected to DC sputtering.

With a Ge—Cr—N material containing 30 to 60 atomic % Ge or Si and 5 to 20 atomic % Cr, such as a composition Ge₅₀Cr₁₀N₄₀, a Si—Cr—N material, a Ge—Si—Cr—N material, or a material that contains Zn and O as principal components (a total of not less than 70 atomic %), the thermal dissipation ratio can be lowered, so that the decrease in recording sensitivity can be reduced.

If the heat conductivity in the second protective layer is too high, the heat extends laterally during recording and it becomes more likely that cross-erase occurs. Thus, the composition ratios in the mixture material of ZnS and materials with a large heat conductivity (SiO₂, Al₂O₃, Cr₂O₃, Ta₂O₅) should preferably be such that ZnS is from 60 to 90 mole %. In the case where ZnS is mixed with materials with a heat conductivity smaller than that of Sio₂ (In₂O₃—SnO₂, In₂O₃, TiO₂, ZnO, SnO₂), it was preferable when ZnS was from 50 to 85 mol %. If these ranges are exceeded and the heat conductivity becomes too large, an increase of jitter due to cross-erase would be 3 % or more. While it is possible to use a Ge—Cr—N material such as Ge₅₀Cr₁₀N₄₀, or a Si—Cr—N material such as Si₅₀Cr₁₀N₄₀ in place of an oxide with a large heat conductivity, such as SiO₂, that would lead to a somewhat poorer productivity as their sputter rates are somewhat lower.

When impurity elements are not less than 10 atomic % relative to the elements constituting the second protective layer, the contrast would decrease and jitter would increase. Thus, impurity elements should preferably be less than 10 atomic % or, more preferably, less than 5 atomic %.

The relationships between the thickness of the second protective layer, the increase in jitter due to cross-erase, and the reflectivity after initialization were determined, as shown in Table 5.

TABLE 5

| Thickness of the | Increase in jitter | |
|---|---|---|
| second protective | due to | Reflectivity after |
| layer (nm) | cross-erase (%) | initialization (%) |
| 12 | 5 | 25 |
| 16 | 2 | 22 |
| 20 | 1.0 | 21 |
| 25 | 1.0 | 20 |
| 30 | 0.8 | 19 |
| 35 | 0.5 | 17 |
| 40 | 0.5 | 15 |
| 50 | 0.4 | 13 |

The results of the examination showed that, as the increase in jitter due to cross-erase must be less than 3% and the reflectivity must be not less than 15% for the overwrite characteristics to be considered practical, the thickness of the second protective layer was in the range between 16 and 40 nm, more preferably between 20 to 35 nm. While optically, the same conditions can be obtained with greater thicknesses at periods of ½ the value of wavelength divided by refractive index, that would result in a deformation or the generation of cracks in the substrate due to stress in the films and the film formation time also extends, and this is not practical. If the reflectivity of the medium is 15% or lower, the modulation of the recoding or reproduction signal would decrease and the AF and tracking would be unstable, resulting in problems that, for example, recording or reproduction cannot be performed. For these reasons, the reflectivity of the medium should preferably be not less than 15%, as stipulated in the DVD-RAM standards.

(Absorption Control Layer)

When Mo, W, Fe, Sb, Mn, Ti, Co, Ge, Pt, Ni, Nb, Pd, Be, or Ta was used instead of Cr in the aforementioned absorption control layer Cr₉₀(Cr₂O₃)₁₀ film, the same results were obtained. Pd and Pt were more preferable as they had lower reactivity with other layers and contributed to increasing the number of times of possible rewrites. With Ni and Co, a less expensive target can be used and therefore the entire preparation cost can be reduced. Cr and Mo had higher corrosion resistance, and the results of their life test were better than others. Ti had a lower and yet still high level of corrosion resistance and provided good characteristics. Tb, Gd, Sm, Cu, Au, Ag, Ca, Al, Zr, Ir, and Hf, for example, were also usable.

Materials that can be used in place of Cr₂O₃ in the aforementioned absorbance control layer Cr₉₀(Cr₂O₃)₁₀ film include: oxides such as SiO₂, SiO, Al₂O₃, BeO, Bi₂O₃, CoO, CaO, CeO₂, Cu₂O, CuO, CdO, Dy₂O₃, FeO, Fe₂O₃, Fe₃O₄, GeO, GeO₂, HfO₂, In₂O₃, La₂O₃, MgO, MnO, MoO₂, MoO₃, NbO, NbO₂, NiO, PbO, PdO, SnO, SnO₂, Sc₂O₃, SrO, ThO₂, TiO₂, Ti₂O₃, TiO, Ta₂O₅, TeO₂, VO, V₂O₃, VO₂, WO₂, WO₃, Y₂O₃, ZrO₂; sulfides such as ZnS, Sb₂S₃, Ga₂S₃, GeS, SnS₂, PbS, Bi₂S₃, SrS, MgS, CrS, CeS, TaS₄; selenides such as SnSe₂, Sb₂Se₃, CdSe, ZnSe, In₂Se₃, Ga₂Se₃, GeSe, GeSe₂, SnSe, PbSe, Bi₂Se₃; fluorides such as CeF₃, MgF₂, CaF₂, TiF₃, NiF₃, FeF₂, FeF₃; borides such as Si, Ge, TiB₂, B₄C, B, CrB, HfB₂, TiB₂, and WB; carbides such as C, Cr₃C₂, Cr₂₃C₆, Cr₇C₃, Fe₃C, Mo₂C, WC, W₂C, HfC, TaC, and CaC₂; nitrides such as Ta—N, AlN, BN, CrN, Cr₂N, GeN, HfN, Si₃N₄, Al—Si—N materials (such as AlSiN₂), Si—N materials, Si—O—N materials, TiN, and ZrN; and other similar compositions. Mixtures of the aforementioned materials may also be used.

Among these, oxides allow the use of less expensive targets and contribute to reducing the entire preparation cost. Among the oxides, SiO₂ and Ta₂O₅ were preferable as they had a lower reactivity and thus contributed to increasing the number of times of possible rewrites. Al₂O₃ has a high heat conductivity and therefore leads to less deterioration of the rewrite characteristics than others when used in a disc of a structure without a reflective layer and/or with a reflective layer. Cr₂O₃ was preferable as it had a high melting point and a high heat conductivity.

With a sulfide, the sputter rate can be increased and the film forming time can be reduced. With a carbide, the hardness of the absorption control layer can be increased such that the flow of the recording film during a number of rewrites can be prevented.

When the melting point of a metal element and/or a dielectric is higher than the melting point (approx. 600° C.) of the recording film, the increase in jitter after rewrites of 10000 times can be reduced. If the melting points of them both are more than 600° C., the increase in jitter can be controlled to less than 3%, which is preferable.

(Substrate)

The present embodiment employs a polycarbonate substrate 1 that has a tracking groove directly in the surface thereof. The substrate that has a tracking groove refers to a substrate in which a groove is provided in the entirety or part of the surface of the substrate to a depth of not less than λ/10n′ (where λ is a recording or reproduction wavelength, and n′ is the refractive index of the substrate material). The groove may be either a continuous track or divided into sections. When the groove depth was approximately λ/6n, crosstalk was reduced as desired. The groove width may be varied at different locations. By making the width narrower towards the center of the disc, problems are less likely to occur during a number of rewrites. The substrate may be either of a format such that recording and reproduction can be performed in both grooves and lands, or a format such that recording is performed in either one. The reflective layer on the first and second disc members may be coated with a UV curing resin to a thickness of approximately 10 μm and the coating may be allowed to cure, and then the two members may be bonded to each other. In this way, the error rate can be further reduced. In the present embodiment, after the two disc members are prepared, their reflective layers 7 are bonded to each other via an adhesive layer. The substrate material may preferably be changed from polycarbonate to a material containing polyolefin as a principal component, since this would increase the hardness of the substrate surface and lead to a 10% reduction of the amount of deformation of the substrate by heat. This, however, would result in an increase of material cost by more than two folds.

### Embodiment 2

A disc (Embodiment 2) was prepared that differed from the disc of Embodiment 1 only in the first protective layer, and the number of overwrites was measured in the same manner as in the case of Embodiment 1. The result showed that the number of overwrites can be increased even when the thickness of the disc is smaller than that of Embodiment 1.

In the first protective layer of Embodiment 2, a first protective layer 2 made of (MgO)₆₀(SnO₂)₄₀ was formed to a thickness of 30 nm.

(Composition and Film Thickness of the First Protective Layer)

The change in reflectivity was determined after rewrites of 10000 times while changing the mole ratios of MgO and SnO₂ in the material of the first protective layer. As the film formation rate changes depending on the amount of MgF₂, the ratio to (ZnS)80(SiO₂)₂₀ was determined. The results are shown in Table 6.

TABLE 6

| MgO content | Change in | |
|---|---|---|
| (mole %) | reflectivity (mV) | Film formation rate |
| 6 | 20 | 2.5 |
| 10 | 10 | 2.0 |
| 15 | 8 | 1.7 |
| 25 | 6 | 1.5 |
| 40 | 3 | 1.2 |
| 60 | 2 | 1.0 |
| 75 | 1 | 0.9 |
| 90 | 0 | 0.7 |
| 100 | 0 | 0.2 |

The results showed that when the amount of MgO was from 10 to 90 mole %, the change in reflectivity was 10 mV or less, the rewrite characteristics were good and the film formation rate was also good at 0.7 or more. Further, when the MgF₂ content was from 20 to 75 mole %, the change in reflectivity was 6 mV or less and thus the rewrite characteristics were even better, with a film formation rate of 1 or more, which is also better. This is due to the fact that, as a MgO—SnO₂ material was used in the aforementioned compositions, there were provided the property that, the hardness of the Mg compound, the change in reflectivity due to the flow of recording film or the deformation of the substrate after rewrites of 10000 times was controlled by the hardness of the Mg compound, and the property that the SnO₂ material has a high film formation rate.

When impurity elements with respect to the elements constituting the first protective layer is 5 atomic % or more, the contrast decreases and jitter increases by more than 1%, impurity elements should preferably be less than 5 atomic % or, more preferably, less than 3 atomic %.

The same rewrite characteristics and film formation characteristics were obtained when MgO in the first protective layer was replaced with another Mg compound, such as MgF₂. MgO is preferable as it can lead to a reduction of material cost to 60% of that in the case of MgF₂. On the other hand, MgF₂ is preferable in that its refractive index n is smaller than that of MgO and that the contrast can be increased by 1.05 times.

The same rewrite characteristics and film formation characteristics were obtained when part of SnO₂ in the first protective layer was replaced with ZnS, Ta₂O₅, In₂O₃, or a mixture thereof.

A material containing In₂O₃ is more preferable as the electric resistance of the target is low such that a DC sputtering can be performed, making it possible to further reduce the tact time. In the case where the material contains ZnS, material cost can be reduced to approximately 80% of that in the case of SnO₂, Ta₂O₅, or In₂O₃, thereby allowing the target preparation cost to be reduced. In the case where the material contains SnO₂, good adhesive property with the boundary layer or the substrate can be obtained. In this case, the result of an accelerated test at 90° C. and humidity of 80% showed that the storage life was increased by more than twice that in the case of ZnS, Ta₂O₅, or In₂O₃, and there was no peeling of the film. In the case of a material containing Ta₂O₃, due to its hardness, the change in reflectivity after rewrites of more than 10000 times was controlled to be 80% of that in the case of SnO₂, ZnS, or In₂O₃.

A similarly large effect of reducing the change in reflectivity was also obtained when SnO₂ in the first protective layer was replaced with Cr₂O₃, Al₂O₃, SiO₂, or a mixture thereof. Specifically, the change in reflectivity was halved as compared with SnO₂. The film formation rate was halved as compared with the case of SnO₂. In the case where the layer contains Cr₂O₃, a good adhesive property with the boundary layer or the substrate can be obtained. The result of an accelerated test at 90° C. and humidity of 80% showed that the storage life was increased by more than three times that in the case of Al₂O₃ or SiO₂, and that there was no peeling of the film. In the case where the layer contains Al₂O₃, the absorption coefficient k is small, and the contrast can be increased by 1.05 times as compared with the case of Cr₂O₃. In the case where the layer contains SiO₂, material cost was reduced to approximately 60% of that in the case of Cr₂O₃ or Al₂O₃, such that the target manufacturing cost can be reduced.

Other details that have not been mentioned here, such as the materials of the recording film, boundary layer, second protective layer, absorption control layer, and reflective layer, their range of thickness, evaluation methods, and so on, are the same as those of Embodiment 1.

### Embodiment 3

### (COMPARATIVE EXAMPLE 1)

A disc (Comparative Example 1) was prepared that was identical to Embodiment 1 except that the first protective layer and the recording film were changed.

The first protective layer consisted of a (ZnS)₈₀ (SiO₂)₂₀ film to a thickness of 130 nm. The recording film consisted of a Ge₂₂Sb₂₂Te₅₆ film to a thickness of 8 nm. When the material cost for the first protective layer was compared in the same manner as in Embodiment 1, the result showed that the material cost was more than twice as much as that of Embodiment 1, as shown in FIG. 10.

### Embodiment 4

A disc (Embodiment 4) was prepared that was different from the disc of Embodiment 1 and that was provided with a Cr₂O₃ boundary layer of 2 nm between the recording film and an upper protective layer. The rewrite characteristics were measured in the same manner as in Embodiment 1, and the result showed that the jitter was as good as that of Embodiment 1.

In the recording film of Embodiment 4, a recording film of Ge_{41.4}Bi_{6.9}Te_{51.7} was formed to a thickness of 8 nm.

(Composition of the Recording Film)

In the disc of Embodiment 4, a recording pattern (random pattern) including 3 T to 11 T in a random manner was recorded, and then the jitter after 10 overwrites was determined. The jitter after 10 overwrites indicated a good value of an average 6.8% for lands and grooves. The jitter shown is indicated in terms of values obtained by dividing an average value of lands and grooves by the clock period T.

Table 7 shows the results of the examination of jitter as the composition of the recording film was varied.

TABLE 7

| Composition of recording | Jitter after 10 |
|---|---|
| film (atomic %) | overwrites (%) |
| Ge_{33.3}Bi_{13.3}Te_{53.3} | 10.0 |
| Ge_{35.3}Bi_{11.8}Te_{52.9} | 9.0 |
| Ge_{36.9}Bi_{10.5}Te_{52.6} | 8.0 |
| Ge_{38.1}Bi_{9.5}Te_{52.4} | 7.5 |
| Ge_{39.1}Bi_{8.7}Te_{52.2} | 7.2 |
| Ge_{40.0}Bi_{8.0}Te_{52.0} | 7.0 |
| Ge_{41.4}Bi_{6.9}Te_{51.7} | 6.8 |
| Ge_{42.4}Bi_{6.1}Te_{51.5} | 6.9 |
| Ge_{43.2}Bi_{5.4}Te_{51.4} | 7.4 |
| Ge_{44.5}Bi_{4.4}Te_{51.1} | 8.2 |
| Ge_{45.5}Bi_{3.6}Te_{50.9} | 8.9 |
| Ge_{46.6}Bi_{2.7}Te_{50.7} | 10.3 |

The results showed that when Ge was from 36.9 to 45.5 atomic %, Bi was from 3.6 to 10.5 atomic %, and Te was from 50.9 to 52.6 atomic %, good rewrite characteristics were obtained with the jitter of not more than 9%. This is due to the fact that, although the contrast is low in the case of a medium with a thin first protective layer, the use of a Ge—Bi—Te material with the aforementioned compositions makes it possible to satisfy optical properties, such as a large contrast between a crystal state and an amorphous state in the recording film material. As a result, the contrast is improved and the erasure ratio is also increased, thereby reducing the jitter during rewrite.

Further, when Ge was from 36.9 to 43.2 atomic %, Bi was from 5.4 to 10.5 atomic %, and Te was from 51.4 to 52.6 atomic %, even better rewrite characteristics were obtained with the jitter of 8% or less.

In addition, when Ge was from 40.0 to 42.4 atomic %, Bi was from 6.1 to 8.0 atomic %, and Te was from 51.5 to 52.0 atomic %, particularly good rewrite characteristics were obtained with the jitter of 7% or less.

(Composition and Film Thickness of the Boundary Layer)

Cr₂O₃ in the boundary layer has the effect of preventing the diffusion of the protective layer material components into the recording film, and improving the crystallization rate. Thus, the boundary layer acts to increase the number of times of possible rewrites, together with the protective layer.

When Bi in the recording film is less than 4 atomic %, the materials mentioned in Embodiment 1 can be used in the boundary layer. Further, there is no need to provide a boundary layer between the recording film and the second protective layer. However, if Bi is 5 atomic % or more, Sn in the second protective layer would react with Bi to change the reflectivity and the crystallization rate. In this case, therefore, a boundary layer must be provided.

Since a Cr compound such as Cr—N, a Fe compound such as Fe—O and Fe—N, a Mo compound such as Mo—O and Mo—N, a W compound such as W—O and W—N, a Ru compound such as Ru—O, and a mixture thereof do not easily react with Bi and are therefore particularly preferable, Cr₂O₃ may be replaced with any of the compounds in the amount of 50 mole % or more.

Other examples of compounds that can be used include a Ta compound such as Ta—O and Ta—N, and a Ti compound such as Ti—O and Ti—N.

Preferably, the thickness of the boundary layer between the recording film and the second protective layer is in the range of 2 to 8 nm.

When the amount of impurity elements is not less than 5 atomic % with respect to the elements constituting the boundary layer, the crystallization rate drops and the increase in jitter during overwrite becomes 1% or more, the amount of impurity elements should preferably be less than 5 atomic % or, more preferably, less than 3 atomic %.

Other details that have not been mentioned with regard to the present embodiment, such as the materials of the first protective layer, boundary layer, second protective layer, absorption control layer, and reflective layer, the range of their thickness, evaluation methods, and so on, are the same as those of Embodiments 1 and 2.

### Embodiment 5

A disc (Embodiment 5) was prepared that was identical to the disc of Embodiment 4 except for the recording film, and the rewrite characteristics were measured in the same manner as in Embodiment 1. The results showed that the jitter was as good as that of Embodiment 1.

The recording film of Embodiment 5 was made of Ge_{40.0}Bi_{4.0}Sb_{4.0}Te_{52.0} and had a thickness of 8 nm.

(Composition of the Recording Film)

In the disc of Embodiment 4, a recording pattern including 3 T to 11 T in a random manner (random pattern) was recorded, and then the jitter was determined after 10 overwrites. The jitter after 10 overwrites showed a good value of an average 7.3% for lands and grooves. The jitter is shown in values obtained by dividing an average value of lands and grooves by the clock period T.

Table 8 shows the results of examining the jitter as the composition of the recording film was changed.

TABLE 8

| Composition of recording | Jitter after 10 |
|---|---|
| film (atomic %) | overwrites (%) |
| Ge_{33.3}Bi_{6.6}Sb_{6.7}Te_{53.3} | 10.3 |
| Ge_{35.3}Bi_{5.9}Sb_{5.9}Te_{52.9} | 9.0 |
| Ge_{36.9}Bi_{5.2}Sb_{5.3}Te_{52.6} | 8.0 |
| Ge_{38.1}Bi_{4.7}Sb_{4.8}Te_{52.4} | 7.8 |
| Ge_{39.1}Bi_{4.3}Sb_{4.4}Te_{52.2} | 7.5 |
| Ge_{40.0}Bi_{4.0}Sb_{4.0}Te_{52.0} | 7.3 |
| Ge_{41.4}Bi_{3.4}Sb_{3.5}Te_{51.7} | 7.5 |
| Ge_{42.4}Bi_{3.0}Sb_{3.1}Te_{51.5} | 7.8 |
| Ge_{43.2}Bi_{2.7}Sb_{2.7}Te_{51.4} | 8.0 |
| Ge_{44.5}Bi_{2.2}Sb_{2.2}Te_{51.1} | 8.4 |
| Ge_{45.5}Bi_{1.8}Sb_{1.8}Te_{50.9} | 9.0 |
| Ge_{46.6}Bi_{1.3}Sb_{1.4}Te_{50.7} | 10.5 |

The results showed that when Ge was from 36.9 to 45.5 atomic %, a sum of Bi and Sb was from 3.6 to 10.5 atomic %, and Te was from 50.9 to 52.6 atomic %, good rewrite characteristics were obtained with the jitter not exceeding 9%. This is due to the fact that, although the contrast is low in the case of a medium with a thin first protective layer, the use of a Ge—Bi—Te material in the above-mentioned compositions makes it possible to satisfy optical properties, such as a large contrast between a crystalline state and an amorphous state in the recording film material. As a result, the contrast is improved and the erasure ratio also increases, so that the jitter during rewrite can be reduced.

Further, when Ge was from 36.9 to 43.2 atomic %, a sum of Bi and Sb was from 5.4 to 10.5 atomic %, and Te was from 51.4 to 52.6 atomic %, better rewrite characteristics were obtained with the jitter not exceeding 8%.

Other details of the present example, such as the materials of the first protective layer, boundary layer, second protective layer, absorption control layer, and reflective layer, the range of their film thickness, evaluation methods, and so on, are the same as those of Embodiments 1, 3 and 4.

### Embodiment 6

A disc (Embodiment 6) was prepared that was identical to the disc of Embodiment 1 except for the first protective layer, which was formed by (ZnS)₆₅(SiO₂)₃₅ to a thickness of 30 nm.

Having a total film thickness of not more than 160 nm, this disc has superior mass producibility. As the first protective layer is thin, as shown in Table 9, material cost can be reduced as compared with the conventional disc (Comparative Example 1) with a film thickness of 130 nm. The material cost is shown in ratios to the film thickness of 130 nm taken as 1.

TABLE 9

| Thickness of first | |
|---|---|
| protective layer (nm) | Material cost |
| 3 | 0.02 |
| 8 | 0.06 |
| 12 | 0.09 |
| 16 | 0.12 |
| 18 | 0.14 |
| 20 | 0.15 |
| 25 | 0.19 |
| 34 | 0.23 |
| 50 | 0.38 |
| 65 | 0.50 |
| 80 | 0.62 |

It is seen that material cost can be reduced by one half when the thickness is not more than 65 nm.

(Evaluation of the Rewrite Characteristics)

In the disc of Embodiment 6, a recording pattern including 3 T to 11 T in a random manner (random pattern) was recorded, and then the modulation was determined after 10 overwrites. Good modulation values of not less than 50% were obtained for both lands and grooves, 52% and 60%, respectively. The jitter after 10 overwrites had a good value of 6.7%. The jitter is shown in values obtained by dividing an average value for lands and grooves by the clock period T.

Then, the number of times of overwrites where the jitter is not more than 13% was determined. In the case of the disc of the present example, the number of times of overwrites can be increased to more than 10000 when the thickness of the first protective layer is 34 nm or more, as shown in FIG. 11 and Table 10.

TABLE 10

| Thickness of first | Number of times of overwrite |
|---|---|
| protective layer (nm) | where jitter is 13% |
| 3 | 200 |
| 8 | 200 |
| 12 | 250 |
| 16 | 500 |
| 20 | 1000 |
| 25 | 5000 |
| 34 | 10000 |
| 50 | 20000 |
| 65 | 30000 |
| 80 | 50000 or more |

As in Embodiment 1, the effect of reducing the jitter to 13% or less upon recording of a random pattern after 10000 overwrites was obtained. Thus, when a material other than a hard material such as a Mg compound was used, it was necessary to make the first protective layer thicker than in the case where the layer contained a Mg compound.

While it is possible to use (ZnS)₆₅(SiO₂)₃₅ by changing the ratio of ZnS and SiO₂, the amount of ZnS should preferably be from 20 to 75 mol %, as this would result in an appropriate refractive index and a large contrast and lead to a modulation of 50% or more.

When SiO₂ and/or a part or all of Sio₂ was replaced with In₂O₃, SnO₂, Al₂O₃, Ta₂O₅, TiO₂, Cr₂O₃, ZnO, or a mixture thereof, the first protective layer was still usable.

The first protective layer was also still usable when SiO₂ and/or a part or all of SiO₂ was replaced with a nitride such as In—N, Sn—N, Al—N, Ta—N, Ti—N, Cr—N, Si—N, or a mixture thereof. As the amount of nitride increases, the likelihood of peeling also increases. Therefore, the amount of nitride in the film should preferably be less than 20 mole %. The materials for the second protective layer were also usable.

Other details that have not be mentioned with regard to the present example, such as the materials of the first protective layer, boundary layer, second protective layer, absorption control layer, reflective layer, the range of their film thickness, evaluation methods, and so on, are the same as those of Embodiments 1, 3, 4, and 5.

### Embodiment 7

A disc (Embodiment 7) was prepared that differed from the disc of Embodiment 1 only in the thickness and composition of the recording film. After recording a signal of 11 T, the signal was erased by a DC light and the erasure characteristics were determined. As the amount of impurity elements increased, the erasure rate dropped, such that although when the impurity elements in the recording film was 1 atomic % an erasure ratio of 23 dB or more was obtained, the erasure ratios were 20 dB and 16 dB when the impurity elements were 3 atomic % and 5 atomic %, respectively. When the lower protective layer was too thick, the contrast was lowered and the erasure ratio was also lowered. On the other hand, when the thickness of the lower protective layer was too thin, the substrate deteriorated upon recording due heat, resulting in a failure to erase sufficiently. The impurity elements herein refer to those elements that are not included in the constituent elements. For example, Se, Sn, As, In, and O are impurity elements. Sb is another impurity element. There is a problem in the overwrite characteristics after 10 or so overwrites. Specifically, the crystallization rate is changed by the addition of Sb, so that the cross-erase overwrite characteristics upon recording in an adjacent track where a recrystallization region has an influence exceed 10%.

Thus, it was learned that an erasure ratio of 20 dB or more is obtained and an overwrite is possible in an medium that has a lower protective layer with a film thickness of from 18 to 65 nm and that has a recording film of which 97 atomic % or more of the composition consists of Ge, Bi, and Te.

Thereafter, the rewrite characteristics under more stringent conditions closer to the practical conditions were determined. A recording pattern including 3 T to 11 T in a random fashion (random pattern) was recorded, and, after 100 overwrites, an adjacent track was overwritten 10 times, followed by the measurement of a cross-erase overwrite jitter. The jitter (to be hereafter referred to as “cross-erase overwrite jitter”) is shown in values obtained by dividing an average value for lands and grooves by the clock period T. The results of examining the jitter as the composition and thickness of the recording film were changed are shown below.

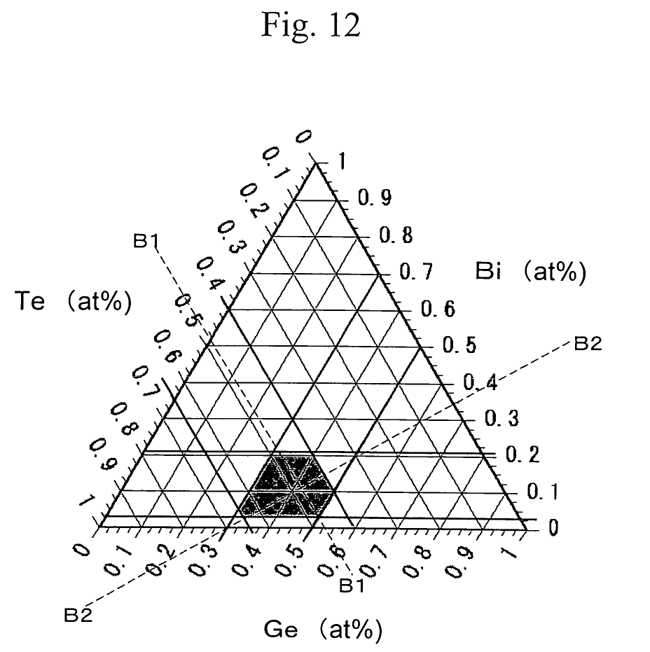

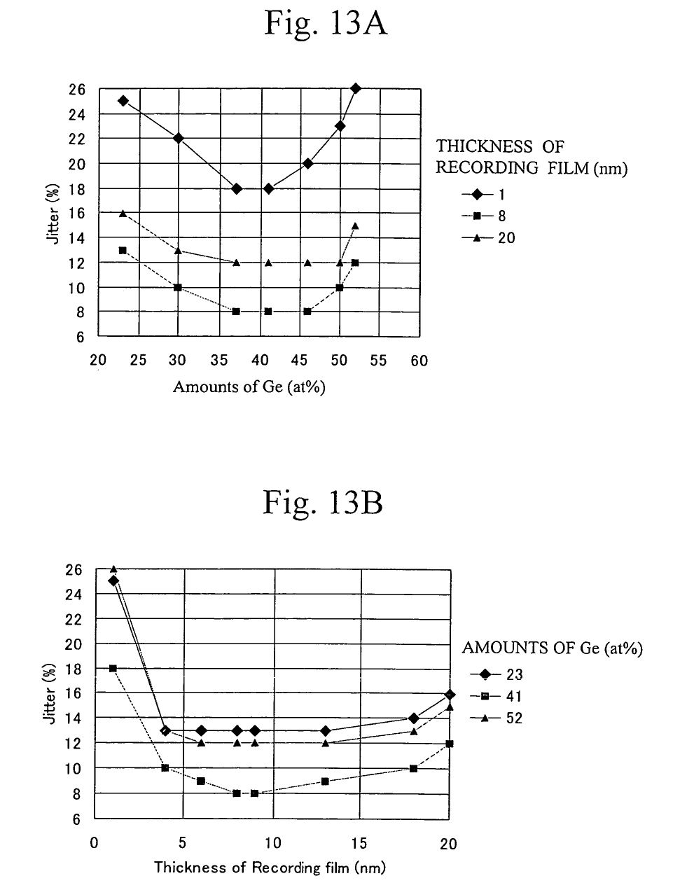

The cross-erase jitter was determined while maintaining the amount of Te at 48 atomic % and changing the amount of Ge along a line B1 in the composition chart of FIG. 12. The results are shown in Table 11 and FIG. 13.

TABLE 11

| Composition | | | | | | | | |
|---|---|---|---|---|---|---|---|---|
| of recording | Cross-erase jitter (%) | | | | | | | |
| film | Recording | 4 | 6 | 8 | | 13 | | |
| (atomic %) | film 1 nm | nm | nm | nm | 9 nm | nm | 18 nm | 20 nm |
| Ge₂₃Bi₂₉Te₄₈ | 25 | 13 | 13 | 13 | 13 | 13 | 14 | 16 |
| Ge₃₀Bi₂₂Te₄₈ | 22 | 10 | 10 | 10 | 10 | 10 | 10 | 13 |
| Ge₃₇Bi₁₅Te₄₈ | 18 | 10 | 9 | 8 | 8 | 9 | 10 | 12 |
| Ge₄₁Bi₁₁Te₄₈ | 18 | 10 | 9 | 8 | 8 | 9 | 10 | 12 |
| Ge₄₆Bi₆Te₄₈ | 20 | 10 | 9 | 8 | 8 | 9 | 10 | 12 |
| Ge₅₀Bi₂Te₄₈ | 23 | 10 | 10 | 10 | 10 | 10 | 10 | 12 |
| Ge₅₂Te₄₈ | 26 | 13 | 12 | 12 | 12 | 12 | 13 | 15 |

It is seen from the above that when Ge is from 30to 50atomic %, Bi was from 2 to 22 atomic %, and the thickness of the recording film was from 4 to 18 nm, good rewrite characteristics were obtained with the cross-erase jitter not exceeding 10%. This is due to the fact that when the amount of Ge is large and that of Bi is too small, the melting point of the recording film rises such that the melting of the protective layer material into the recording film occurs, thereby reducing the crystallization rate, while on the other hand, when the amount of Ge is small and that of Bi is too large, the contrast decreases and the increase of jitter can be prevented. Another reason is that when the thickness of the recording film is too large, recrystallization occurs such that cross-erase increases, and when the recording film is too thin, the contrast decreases and the increase in jitter can be prevented.

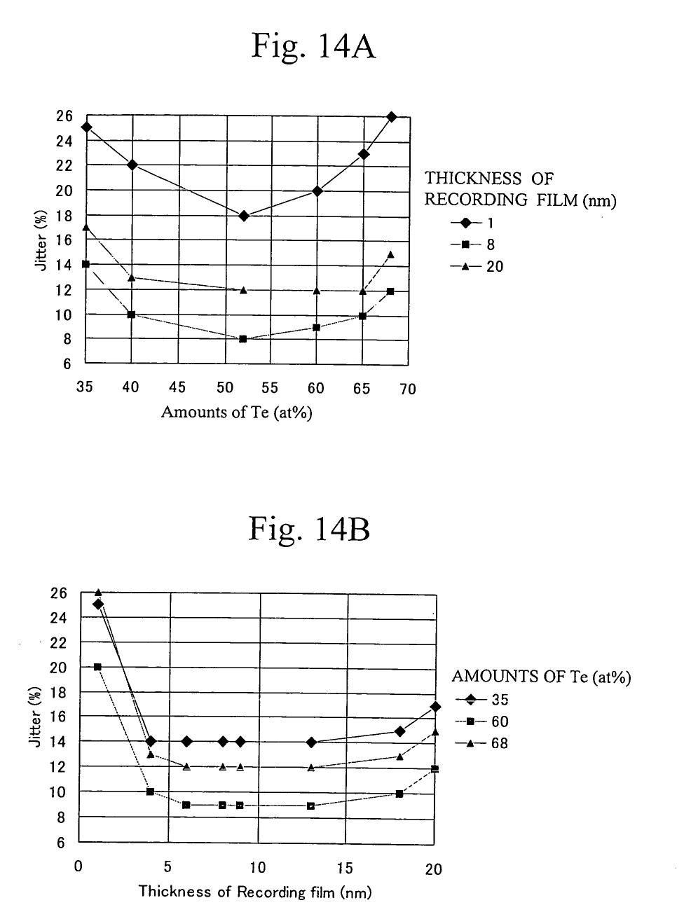

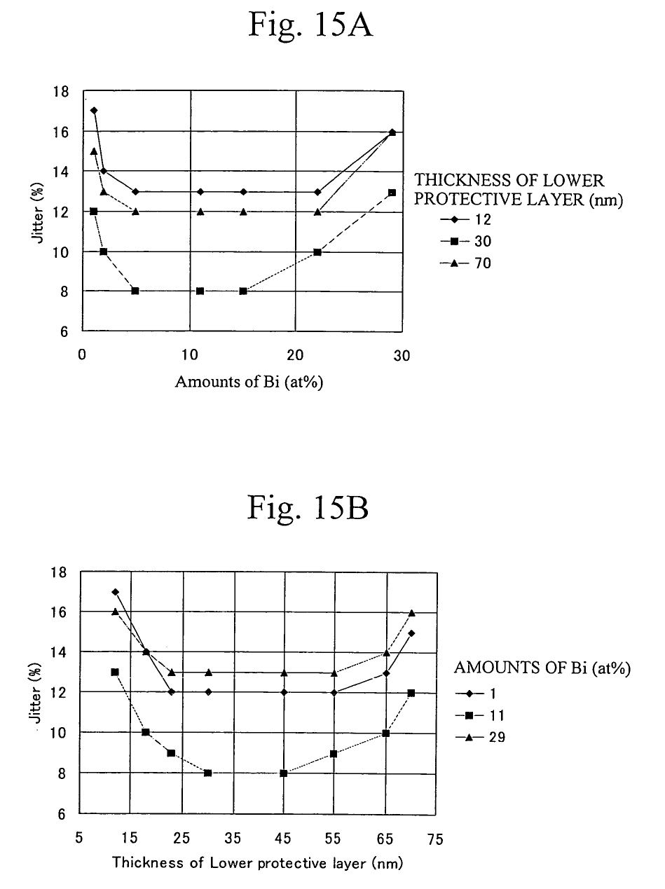

Cross-erase jitter was determined while changing the film thickness of the recording film and changing the amount of Te between Ge₃₀Te₇₀ and Ge₆₅Bi₃₅ (along a line B2 in the composition chart of FIG. 12) in the composition of the recording film. The results are shown in Table 12 and FIG. 14.

TABLE 12

| | Cross-erase jitter (%) | | | | | | | |
|---|---|---|---|---|---|---|---|---|
| Amount of Te | Recording | 4 | 6 | 8 | | 13 | | |
| (atomic %) | film 1 nm | nm | nm | nm | 9 nm | nm | 18 nm | 20 nm |
| 35 | 25 | 14 | 14 | 14 | 14 | 14 | 15 | 17 |
| 40 | 22 | 10 | 10 | 10 | 10 | 10 | 10 | 13 |
| 52 | 18 | 10 | 9 | 8 | 8 | 9 | 10 | 12 |
| 60 | 20 | 10 | 9 | 9 | 9 | 9 | 10 | 12 |
| 65 | 23 | 10 | 10 | 10 | 10 | 10 | 10 | 12 |
| 68 | 26 | 13 | 12 | 12 | 12 | 12 | 13 | 15 |

It is seen from the above that when Te was from 40 to 65 atomic %, good rewrite characteristics were obtained with the cross-erase jitter not exceeding 10%. This is due to the fact that when the amount of Te is too large, segregation occurs in the recording film components during overwrite, while when the amount of Te is too little, the contrast decreases and the increase in jitter can be prevented.

Cross-erase jitter was determined while maintaining the thickness of the recording film at 8 nm and the amount of Te in the composition of the recording film at 48 atomic % and while changing the thickness of the lower protective layer. The results are shown in Tables 13 and 15.

TABLE 13

| Composition | | | | | | | | |
|---|---|---|---|---|---|---|---|---|
| of recording | Cross-erase jitter (%) | | | | | | | |
| film | 12 | 18 | 23 | 30 | | | | |
| (atomic %) | nm | nm | nm | nm | 45 nm | 55 nm | 65 nm | 70 nm |
| Ge₅₁Bi₁Te₄₈ | 17 | 14 | 12 | 12 | 12 | 12 | 13 | 15 |
| Ge₅₀Bi₂Te₄₈ | 14 | 10 | 10 | 10 | 10 | 10 | 10 | 13 |
| Ge₄₆Bi₆Te₄₈ | 13 | 10 | 9 | 8 | 8 | 9 | 10 | 12 |
| Ge₄₁Bi₁₁Te₄₈ | 13 | 10 | 9 | 8 | 8 | 9 | 10 | 12 |
| Ge₃₇Bi₁₅Te₄₈ | 13 | 10 | 9 | 8 | 8 | 9 | 10 | 12 |
| Ge₃₀Bi₂₂Te₄₈ | 13 | 10 | 10 | 10 | 10 | 10 | 10 | 12 |
| Ge₂₃Bi₂₉Te₄₈ | 16 | 10 | 13 | 13 | 13 | 13 | 14 | 16 |

It is seen from the above that when Bi was from 2 to 22 atomic %, Ge was from 30 to 50 atomic %, and Te was from 40 to 65 atomic %, good rewrite characteristics were obtained with the cross-erase jitter not exceeding 10%. This is due to the fact that when the amount of Ge is large and that of Bi is too little, the melting point of the recoding film rises and the melting of the protective layer material into the recording film occurs, resulting in a reduction of the crystallization rate, while when the amount of Ge is small and that of Bi is too large, the contrast decreases and the increase in jitter can be prevented. Another reason is that when the lower protective layer is too thick, the contrast decreases, while when the thickness is too small, the substrate deteriorates upon rewrite due to heat, thereby preventing the increase in jitter.

When all of the above were considered, it was learned that good rewrite characteristics under practical conditions were obtained with the jitter not exceeding 10% when the composition of the recording film was such that Ge was from 30 to 50 atomic %, Bi was from 2 to 22 atomic %, Te was from 40 to 65 atomic %, the thickness of the recording film was from 4 to 18 nm, and the thickness of the lower protective film was from 18 to 65 nm.

It was further learned that when the composition of the recording film was such that Ge was from 37 to 46 atomic %, Bi was from 6 to 15 atomic %, Te was from 52 to 60 atomic %, the thickness of the recording film was from 6 to 13 nm, and the thickness of the lower protective layer was from 23 to 55 nm, good rewrite characteristics under practical conditions were obtained with the cross-erase jitter not exceeding 9% and there was obtained a margin.

Other details that have not been mentioned with reference to the present example, such as the material of the first protective layer, boundary layer, second protective layer, absorption control layer, reflective layer, the ranges of their thickness, evaluation methods, and so on, are the same as those of Embodiments 1 to 6.

### Embodiment 8

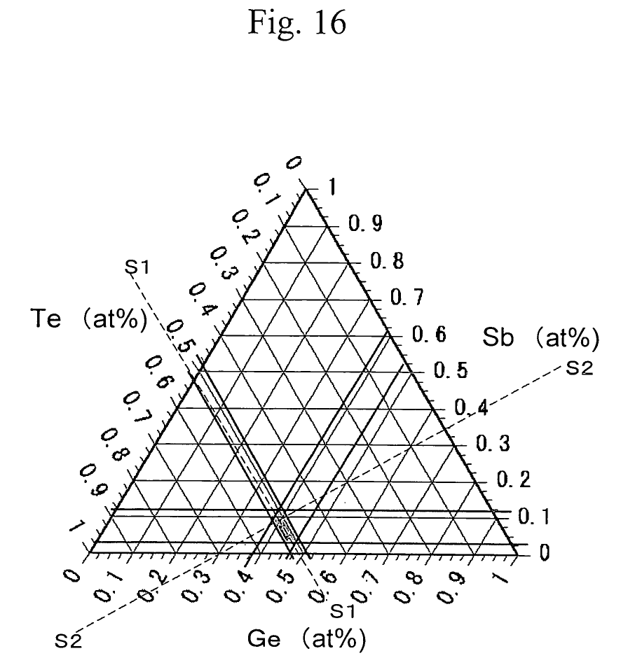

A disc was prepared that was identical to the disc of Embodiment 7 except for the lower protective layer and the fact that the recording film was made of Ge, Sb, and Te, and its rewrite characteristics under conditions similar to practical conditions were determined. A recording pattern including 3 T to 11 T in a random fashion (random pattern) was recorded, and, after 100 overwrites, an adjacent track was overwritten 10 times, followed by the measurement of the cross-erase overwrite jitter. The jitter is shown in values obtained by dividing an average value for lands and grooves by the clock period T (to be hereafter referred to as“cross-erase overwrite jitter”). The results of analyzing the jitter while changing the composition and thickness of the recording film are shown in Tables 14 to 16 and FIGS. 16 to 18.

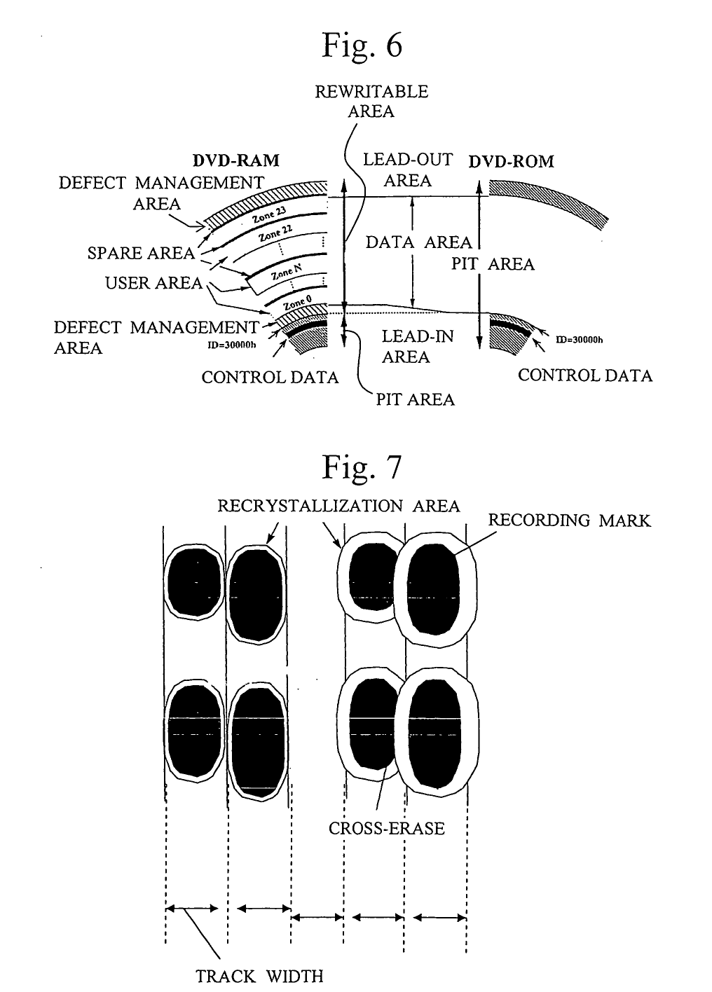

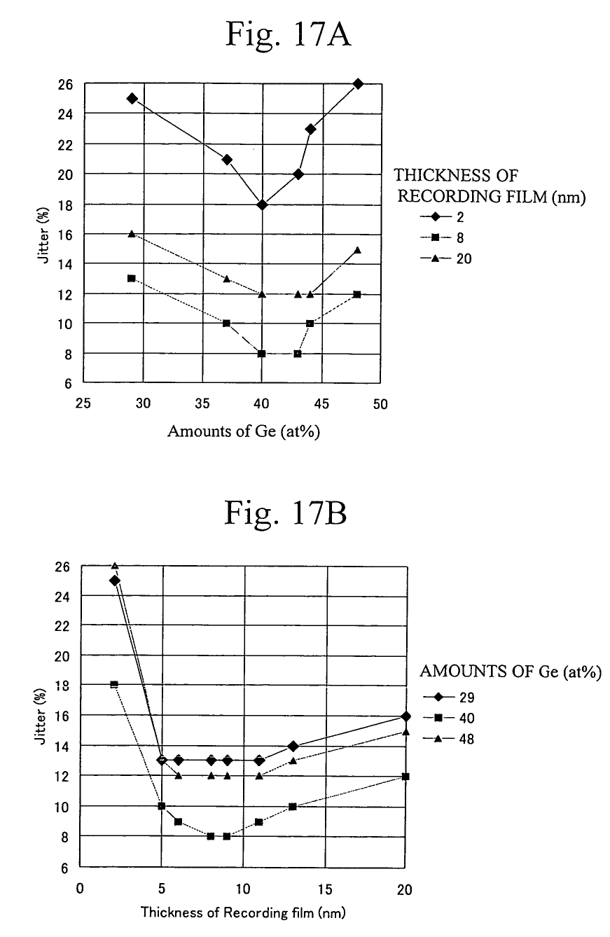

Cross-erase jitter was determined while maintaining the amount of Te at 52 atomic % and changing the amount of Ge in the recording film (on a line S1 in FIG. 6). The results are shown in Table 14 and FIG. 17.

TABLE 14

| Composition | | | | | | | | |
|---|---|---|---|---|---|---|---|---|
| of recording | Cross-erase jitter (%) | | | | | | | |
| film | Recording | 5 | 6 | 8 | | 11 | | |
| (atomic %) | film 2 nm | nm | nm | nm | 9 nm | nm | 13 nm | 20 nm |
| Ge₂₉Sb₁₉Te₅₂ | 25 | 13 | 13 | 13 | 13 | 13 | 14 | 16 |
| Ge₃₇Sb₁₁Te₅₂ | 21 | 10 | 10 | 10 | 10 | 10 | 10 | 13 |
| Ge₃₉Sb₉Te₅₂ | 18 | 10 | 9 | 8 | 8 | 9 | 10 | 12 |
| Ge₄₂Sb₆Te₅₂ | 20 | 10 | 9 | 8 | 8 | 9 | 10 | 12 |
| Ge₄₄Sb₄Te₅₂ | 23 | 10 | 10 | 10 | 10 | 10 | 10 | 12 |
| Ge₅₀Sb₂Te₅₂ | 26 | 13 | 12 | 12 | 12 | 12 | 13 | 15 |

It is seen from the above that good rewrite characteristics were obtained with the cross-erase jitter not exceeding 10% when Ge was from 37 to 46 atomic %, Sb was from 4 to 11 atomic %, and the thickness of the recording film was from 5 to 13 nm. This is due to the fact that when the amount of Ge is large and that of Sb is too small, the melting point of the recording film rises and the melting of the protective layer material into the recording film occurs, thereby reducing the crystallization rate, while when the amount of Ge is small and that of Sb is too large, the contrast decreases and the increase of jitter can be prevented. Another reason is that when the thickness of the recording film is too large, recrystallization occurs such that cross-erase increases, while when the recording film is too thin, the contrast decreases and the increase of jitter can be prevented.

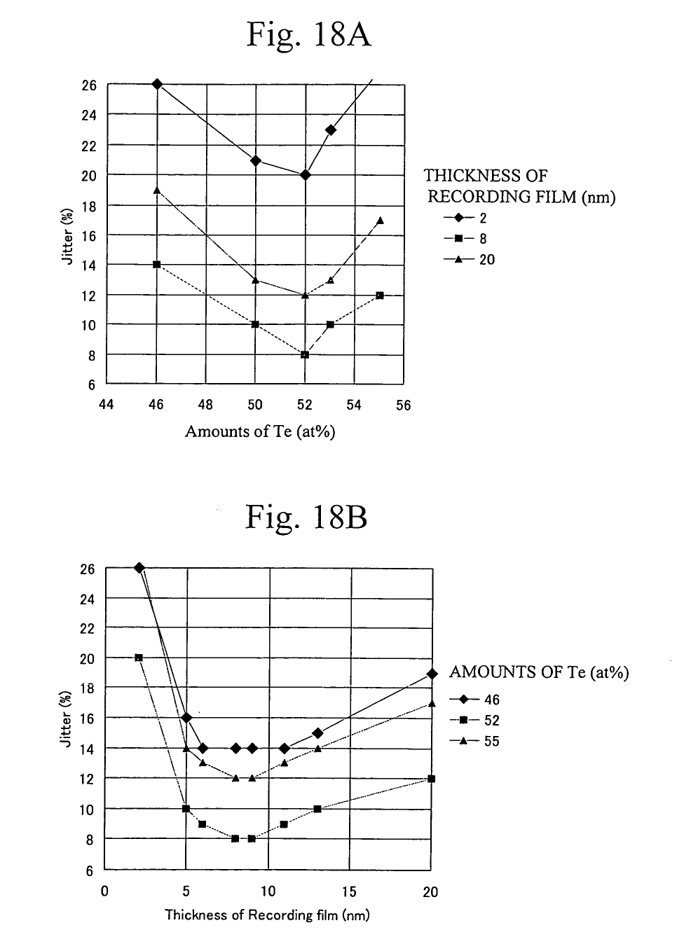

Cross-erase jitter was determined while changing the thickness of the recording film and also changing the amount of Te in the composition of the recording film between Ge₃₀Te₇₀ and Ge₆₅Sb₃₅ (on a line S2 in the composition chart of FIG. 16). The results are shown in Table 15 and FIG. 18.

TABLE 15

| | Cross-erase jitter (%) | | | | | | | |
|---|---|---|---|---|---|---|---|---|
| Amount of Te | Recording | 5 | 6 | 8 | | 11 | | |
| (atomic %) | film 2 nm | nm | nm | nm | 9 nm | nm | 13 nm | 20 nm |
| 46 | 26 | 16 | 14 | 14 | 14 | 14 | 15 | 19 |
| 50 | 21 | 10 | 10 | 10 | 10 | 10 | 10 | 13 |
| 52 | 20 | 10 | 9 | 8 | 8 | 9 | 10 | 12 |
| 53 | 23 | 10 | 10 | 10 | 10 | 10 | 10 | 13 |
| 55 | 27 | 14 | 13 | 12 | 12 | 13 | 14 | 17 |

It is seen from the above that good rewrite characteristics were obtained with the cross-erase jitter not exceeding 10% when Te was from 50 to 53 atomic %. This is due to the fact that when the amount of Te is too large, segregation occurs in the recording film components during overwrite, while when the amount of Te is too small, the contrast decreases and the increase in jitter can be prevented.

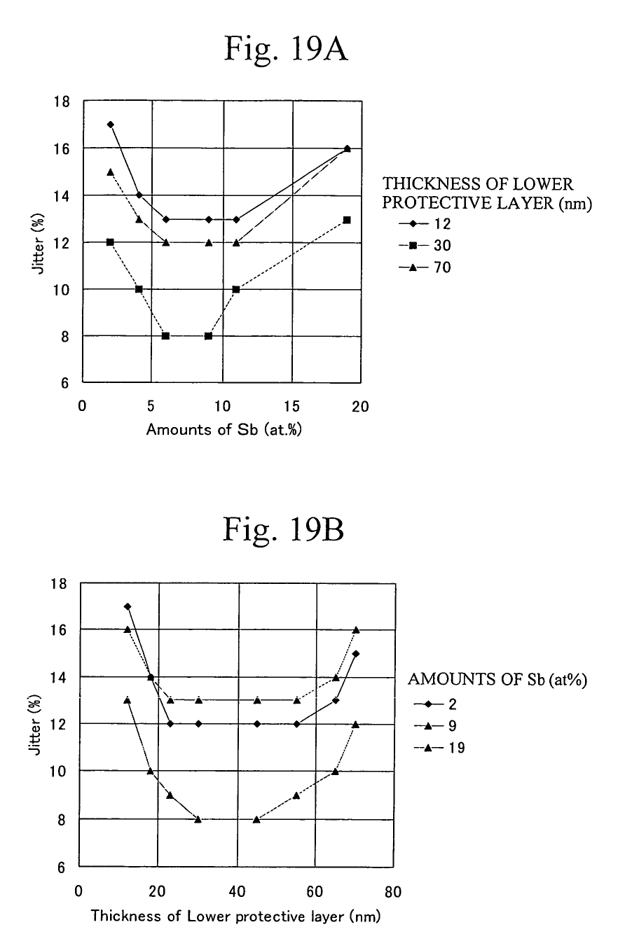

Cross-erase jitter was determined while maintaining the thickness of the recording film at 8 nm and the amount of Te at 52 atomic % in the composition of the recording film and while changing the amount of Sb and the thickness of the lower protective layer. The results are shown in Table 18 and FIG. 19.

TABLE 16

| Composition | | | | | | | | |
|---|---|---|---|---|---|---|---|---|
| of recording | Cross-erase jitter (%) | | | | | | | |
| film | 12 | 18 | 23 | 30 | | | | |
| (atomic %) | nm | nm | nm | nm | 45 nm | 55 nm | 65 nm | 70 nm |
| Ge₄₆Sb₂Te₅₂ | 14 | 14 | 12 | 12 | 12 | 12 | 13 | 15 |
| Ge₄₄Sb₄Te₅₂ | 17 | 10 | 10 | 10 | 10 | 10 | 10 | 13 |
| Ge₄₂Sb₆Te₅₂ | 14 | 10 | 9 | 8 | 8 | 9 | 10 | 12 |
| Ge₃₉Sb₉Te₅₂ | 13 | 10 | 9 | 8 | 8 | 9 | 10 | 12 |
| Ge₃₇Sb₁₁Te₅₂ | 13 | 10 | 10 | 10 | 10 | 10 | 10 | 12 |
| Ge₂₉Sb₁₉Te₅₂ | 16 | 14 | 13 | 13 | 13 | 13 | 14 | 16 |

It is seen from the above that good rewrite characteristics were obtained with the cross-erase jitter not exceeding 10% when Sb was from 4 to 11 atomic %, Ge was from 37 to 46 atomic %, Te was from 50 to 53 atomic %, and the thickness of the lower protective layer was from 18 to 65 nm. This is due to the fact that when the amount of Ge is large and that of Sb is too small, the melting point of the recording film rises and the melting of the protective layer material into the recording film occurs, thereby reducing the crystallization rate, while when the amount of Ge is small and that of Sb is too large, the contrast decreases and the increase of jitter can be prevented. Another reason is that when the lower protective layer is too thick, the contrast decreases, while when the thickness is too small, the substrate deteriorates due to heat during rewrite, thereby preventing the increase in jitter.

When all of the above were considered, it was learned that good rewrite characteristics were obtained with the cross-erase jitter not exceeding 10% when the composition of the recording film was such that Ge was from 37 to 46 atomic %, Sb was from 4 to 11 atomic %, Te was from 50 to 53 atomic %, the thickness of the recording film was from 5 to 13 nm, and the thickness of the lower protective layer was from 18 to 65 nm.

In the range of composition in which good rewrite characteristics can be obtained, as the amount of impurity elements increases, the erasure ratio drops, such that when the amount of impurity elements in the recording film exceeds 3 atomic %, the cross-erase jitter increases beyond 10%, which is not preferable. When Ge is from 39 to 42 atomic %, Sb is from 6 to 9 atomic %, Te is 52 atomic %, and the thickness of the lower protective layer is from 23 to 55 nm, the cross-erase jitter can be reduced to 9% or less, which is more preferable.

The impurity elements herein refer to those elements that are not included in the constituent elements. Examples include Se, Sn, As, In, and O. Another impurity element is Bi. There is a problem in the overwrite characteristics regarding 10 or so overwrites. Specifically, as Bi is added, the crystallization rate changes, such that the cross-erase overwrite characteristics upon recording in an adjacent track where the recrystallization region has an influence exceeds 10%.

Other details that have not been mentioned with regard to the present example, such as the material of the first protective layer, boundary layer, second protective layer, absorption control layer, reflective layer, the range of their film thickness, evaluation methods, and so on, are the same as those of Embodiments 1 to 7.

### Embodiment 9

A disc (Embodiment 9) was prepared that differed from the disc of Embodiment 1 in the thickness and composition of the recording film, the material of the lower protective layer, and the thickness of the substrate. After recording signals of 2 T to 8 T in a random manner using a blue (410 nm) laser beam of NA 0.85, jitter was measured. The evaluation conditions in this case were such that the linear velocity was 3.8 m/s, the equalizer comprised a limit equalizer, the detection window width was 15.2 ns, and the thickness of the substrate on the laser light-incident side was approximately 0.1 mmt. In the lower protective layer material, a SnO₂ film of a thickness in the range from 18 to 65 nm was used. 8 T was recorded and then erased with DC light, and then the erase characteristics were determined. The result showed that as the amount of impurity elements increased, the erasure ratio dropped. Specifically, when the amount of the impurity elements in the recording film was 1 atomic %, an erasure ratio of 23 dB was obtained, but the erasure ratio dropped to 20 dB when the amount of impurity elements was 3 atomic % and to 16 dB when the impurity elements were 5 atomic %. When the lower protective layer was too thick, the contrast dropped and therefore the erasure ratio also dropped. When the lower protective layer was too thin, the substrate deteriorated due to heat upon recording such that erasure could not be performed sufficiently.

Thus, it was learned that an erasure ratio of 20 dB or higher can be obtained and overwrite is possible with blue laser in a medium with a lower protective film thickness of from 18 to 65 nm and with a recording film with a composition of which 97 atomic % or more consists of Ge, Bi, and Te.

Thereafter, the rewrite characteristics under more stringent conditions similar to practical conditions were determined. A recording pattern including 2 T to 8 T in a random fashion (random pattern) was recorded and, after 10 overwrites, the overwrite jitter was measured. The jitter is shown in values obtained by dividing the value for grooves by the clock period T. (Hereafter, the jitter will be referred to as an overwrite jitter.) The results of determining the jitter as the composition and thickness of the recording film were changed are shown in Table 17.

Cross-erase jitter was determined while maintaining the amount of Te at 48 atomic % and changing the composition of the recording film along a line B1 in the composition chart of FIG. 12. The results are shown in Table 17.

TABLE 17

| Composition | | | | | | | | |
|---|---|---|---|---|---|---|---|---|
| of recording | Overwrite jitter (%) | | | | | | | |
| film | Recording | 4 | 6 | 8 | | 13 | | |
| (atomic %) | film 1 nm | nm | nm | nm | 9 nm | nm | 18 nm | 20 nm |
| Ge₂₃Bi₂₉Te₄₈ | 25 | 13 | 13 | 13 | 13 | 13 | 14 | 16 |
| Ge₃₀Bi₂₂Te₄₈ | 22 | 10 | 10 | 10 | 10 | 10 | 10 | 13 |
| Ge₃₇Bi₁₅Te₄₈ | 18 | 10 | 9 | 8 | 8 | 9 | 10 | 12 |
| Ge₄₁Bi₁₁Te₄₈ | 18 | 10 | 9 | 8 | 8 | 9 | 10 | 12 |
| Ge₄₆Bi₆Te₄₈ | 20 | 10 | 9 | 8 | 8 | 9 | 10 | 12 |
| Ge₅₀Bi₂Te₄₈ | 23 | 10 | 10 | 10 | 10 | 10 | 10 | 12 |
| Ge₅₂Te₄₈ | 26 | 13 | 12 | 12 | 12 | 12 | 13 | 15 |

It is seen from the above that good rewrite characteristics were obtained with the overwrite jitter not exceeding 10% when Ge was from 30 to 50 atomic %, Bi was from 2 to 22 atomic %, and the thickness of the recording film was from 4 to 18 nm. This is due to the fact that when the amount of Ge is large and that of Bi is too small, the melting point of the recording film rises and the melting of the protective layer material into the recording film occurs, thereby reducing the crystallization rate, while when the amount of Ge is small and that of Bi is too large, the contrast decreases and the increase of jitter can be prevented. Another reason is that when the recording film is too thick, recrystallization occurs, which leads to an increase in cross-erase, while when the recording film is too thin, the contrast decreases, thereby preventing the increase in jitter.

Overwrite jitter was determined while maintaining the thickness of the recording film at 8 nm and changing the amount of Te in the composition of the recording film between Ge₃₀Te₇₀ and Ge₆₅Bi₃₅ (along a line B2 in the composition chart of FIG. 12). The results are shown in Table 18.

TABLE 18

| Amount of Te (atomic %) | Overwrite jitter (%) |
|---|---|
| 35 | 14 |
| 40 | 10 |
| 52 | 8 |
| 60 | 9 |
| 65 | 10 |
| 68 | 12 |

It is seen from the above that good rewrite characteristics were obtained with the overwrite jitter not exceeding 10% when Te was from 40 to 65 atomic %. This is due to the fact that when the amount of Te is too large, segregation in the recording film components occurs during overwrite, while the contrast decreases when the amount of Te is too small, thereby preventing the increase in jitter.

Overwrite jitter was determined while maintaining the thickness of the recording film at 8 nm and the amount of Te at 48 atomic % and changing the amount of Bi and the thickness of the lower protective layer. The results are shown in Table 19.

TABLE 19

| Composition | | | | | | | | |
|---|---|---|---|---|---|---|---|---|
| of recording | Overwrite jitter (%) | | | | | | | |
| film | 12 | 18 | 23 | 30 | | | | |
| (atomic %) | nm | nm | nm | nm | 45 nm | 55 nm | 65 nm | 70 nm |
| Ge₅₁Bi₁Te₄₈ | 17 | 14 | 12 | 12 | 12 | 12 | 13 | 15 |
| Ge₅₀Bi₂Te₄₈ | 14 | 10 | 10 | 10 | 10 | 10 | 10 | 13 |
| Ge₄₆Bi₆Te₄₈ | 13 | 10 | 9 | 8 | 8 | 9 | 10 | 12 |
| Ge₄₁Bi₁₁Te₄₈ | 13 | 10 | 9 | 8 | 8 | 9 | 10 | 12 |
| Ge₃₇Bi₁₅Te₄₈ | 13 | 10 | 9 | 8 | 8 | 9 | 10 | 12 |
| Ge₃₀Bi₂₂Te₄₈ | 13 | 10 | 10 | 10 | 10 | 10 | 10 | 12 |
| Ge₂₃Bi₂₉Te₄₈ | 16 | 10 | 13 | 13 | 13 | 13 | 14 | 16 |

It is seen from the above that good rewrite characteristics were obtained with the overwrite jitter not exceeding 10% when Bi was from 2 to 22 atomic %, Ge was from 30 to 50 atomic %, Te was from 40 to 65 atomic %, and the thickness of the lower protective layer was from 18 to 65 nm. This is due to the fact that when the amount of Ge is large and that of Bi is too small, the melting point of the recording film rises and the melting of the protective layer material into the recording film occurs, thereby reducing the crystallization rate, while when the amount of Ge is small and that of Bi is too large, the contrast decreases and the increase of jitter can be prevented. Another reason is that when the lower protective layer is too thick, the contrast decreases, while when the lower protective layer is too thin, the substrate deteriorates due to heat during overwrite, thereby preventing the increase in jitter.

When all of the above were considered, it was learned that good rewrite characteristics under practical conditions were obtained with the overwrite jitter not exceeding 10% in a blue-laser medium as well when the composition of the recording film was such that Ge was from 30 to 50 atomic %, Bi was from 2 to 22 atomic %, Te was from 40 to 65 atomic %, the thickness of the recording film was from 4 to 18 nm, and the thickness of the lower protective film was from 18 to 65 nm.

It was further learned that when the composition of the recording film was such that Ge was from 37 to 46 atomic %, Bi was from 6 to 15 atomic %, Te was from 52 to 60 atomic %, the thickness of the recording film was from 6 to 13 nm, and the thickness of the lower protective layer was from 23 to 55 nm, good rewrite characteristics under practical conditions were obtained with the overwrite jitter not exceeding 9% and there was also obtained a margin.

The same rewrite characteristics and film formation characteristics were obtained when part of SnO₂ in the first protective layer was replaced with ZnS, Ta₂O₅, In₂O₃, or a mixture thereof.

When SnO₂ in the first protective layer was replaced with Cr₂O₃, Al₂O₃, SiO₂, or a mixture thereof, a similarly large effect of reducing the change in reflectivity was obtained. Specifically, the change in reflectivity was halved as compared with SnO₂. The film formation rate was also halved as compared with SnO₂. In the case where the layer contained Cr₂O₃, a good adhesive property with the boundary layer or the substrate was obtained, and the result of an accelerated test at 90° C. and humidity of 80% showed that the storage life was more than three times as long as that in the case of Al₂O₃ or SiO₂, and that there was no peeling of the film. In the case where the layer contained Al₂O₃, the absorption coefficient k was small and the contrast was increased by 1.05 times as compared with the case of Cr₂O₃. In the case where the layer contained SiO₂, material cost was reduced to approximately 60% of that in the case of Cr₂O₃ or Al₂O₃, thereby allowing the target manufacturing cost to be reduced.

When the content of impurity elements relative to the elements constituting the first protective layer was 5 atomic % or more, the contrast drops and the jitter increases by 1% or more, the content of impurity element should preferably be less than 5 atomic % or, more preferably, less than 3 atomic %.

Other details that have not been mentioned with regard to the present example, such as the material of the first protective layer, boundary layer, second protective layer, absorption control layer, and reflective layer, the range of their film thickness, evaluation methods, and so on, are the same as those of Embodiments 1 to 8.

1. An information recording medium in which a number of rewrites can be performed, wherein a recording is performed by change of atomic arrangement caused by irradiation of light, said information recording medium comprising a substrate on which the following are formed in the mentioned order, as seen from a light-incident side of said substrate:
a first protective layer with a thickness in the range of 18 nm or more but 65 nm or less and containing a Mg compound of an amount of not less than 10 mole %;
a recording film;
a second protective layer; and
a reflective layer, wherein
said recording film contains Ge, either Sb or Bi, and Te, wherein the content of Ge is in the range of 36.9 atomic % or more but 45.5 atomic % or less, the content of a sum of Bi and Sb is in the range of 3.6 atomic % or more but 10.5 atomic % or less, and the content of Te is in the range of 50.9 atomic % or more but 52.6 atomic % or less.

2. The information recording medium according to claim 1, wherein the content of Bi in said recording film is not more than 4 atomic %.

3. The information recording medium according to claim 1, wherein the content of Bi in said recording film is not less than 5 atomic %, said information recording medium further comprising a boundary layer between said recording film and said second protective layer.

4. The information recording medium according to claim 1, wherein said boundary layer formed between said recording film and said second protective layer, and said boundary layer contains a Cr compound, a Fe compound, a Mo compound, a W compound, or a Ru compound, wherein the content of total of the compound is not less than 50 mole %.

5. The information recording medium according to claim 1, wherein said first protective layer is composed any one of MgO—ZnS, MgO—SnO₂, MgO—Ta₂O₃, or MgO—In₂O₃, and wherein the content of MgO in said first protective layer is in the range of 10 mole % or more but 90 mole % or less.

6. The information recording medium according to claim 1, wherein said first protective layer is composed any one of MgF₂—ZnS, MgF₂—SnO₂, MgF₂—Ta₂O₃, or MgF₂—In₂O₃, and wherein the content of MgF₂ in said first protective layer is in the range of 10 mole % or more but 90 mole % or less.

7. The information recording medium according to claim 1, wherein the thickness of said first protective layer is in the range of 18 nm or more but 65 nm or less, and wherein said first protective layer is composed any one of MgO—Cr₂O₃, MgO—Al₂O₃, or MgO—SiO₂, wherein the content of MgO in said first protective layer is in the range of 10 mole % or more but 90 mole % or less.

8. The information recording medium according to claim 1, wherein the thickness of said first protective layer is in the range of 18 nm or more but 65 nm or less, and wherein said first protective layer is composed any one of MgF—Cr₂O₃, MgF—Al₂O₃, or MgF—SiO₂, wherein the content of MgF in said first protective layer is in the range of 10 mole % or more but 90 mole % or less.

9. An information recording medium in which a number of rewrites can be performed, wherein a recording is performed by change of atomic arrangement caused by irradiation of light, said information recording medium comprising a substrate on which the following are formed in the mentioned order, as seen from a light-incident side of said substrate:
a lower protective layer with a thickness of 18 nm or more but 65 nm or less;
a recording film;
an upper protective layer; and
a reflective layer, wherein
the component of said recording layer representing less than 97 atomic % of the total number of atoms thereof is composed of Ge, Bi and Te.

10. An information recording medium in which a number of rewrites can be performed, wherein a recording is performed by change of atomic arrangement caused by irradiation of light, said information recording medium comprising a substrate on which the following are formed in the mentioned order, as seen from a light-incident side of said substrate:
a lower protective layer with a thickness of 18 nm or more but 65 nm or less;
a recording film;
an upper protective layer; and
a reflective layer, wherein
the thickness of said recording film is in the range of 4 nm or more but 18 nm or less; and
the component of said recording layer representing not less than 97 atomic % of the total number of atoms thereof is composed of Ge, Bi and Te, wherein the content of Ge is in the range of 30 atomic % or more but 50 atomic % or less, the content of Bi is in the range of 2 atomic % or more but 22 atomic % or less, the content of Te is in the range of 40 atomic % or more but 65 atomic % or less, and wherein
said lower protective layer contains a Mg compound of an amount of not less than 10 mole %.

11. The information recording medium according to claim 10, wherein, in said recording film, the content of Ge is in the range of 37 atomic % or more but 46 atomic % or less, the content of Bi is in the range of 6 atomic % or more but 15 atomic % or less, and the content of Te is in the range of 52 atomic % or more but 60 atomic % or less, wherein the thickness of said recording film is in the range of 6 nm or more but 13 nm or less, and wherein the thickness of said lower protective layer is in the range of 23 nm or more but 55 nm or less.

12. The information recording medium according to claim 10, wherein said lower protective layer contains any one of SnO₂, Cr₂O₃, Al₂O₃, or SiO₂.

13. The information recording medium according to claim 10, wherein said lower protective layer consists any one of SnO₂, SnO₂—ZnS, SnO₂—Ta₂O₅, or SnO₂—In₂O₃.

14. An information recording medium in which a number of rewrites can be performed, wherein a recording is performed by change of atomic arrangement caused by irradiation of light, said information recording medium comprising a substrate on which the following are formed in the mentioned order, as seen from a light-incident side of said substrate:
a lower protective layer with a thickness in the range of 18 nm or more but 65 nm or less;
a recording film;
an upper protective layer; and
a reflective layer, wherein
the thickness of said recording film is in the range of 5 nm or more but 13 nm or less; and
Ge, Sb, and Te account for not less than 97 atomic % of the composition of said recording film, wherein the content of Ge is in the range of 37 atomic % or more but 46 atomic % or less, the content of Sb is in the range of 4 atomic % or more but 11 atomic % or less, and the content of Te is in the range of 50 atomic % or more but 53 atomic % or less, and wherein
said lower protective layer contains a Mg compound by not less than 10 mole %.

15. The information recording medium according to claim 14, wherein the content of Ge is in the range of 39 atomic % or more but 42 atomic % or less, the content of Sb is in the range of 6 atomic % or more but 9 atomic % or less, and the content of Te is 52 atomic % in the recording film, and wherein the thickness of said lower protective layer is in the range of 23 nm or more but 55 nm or less.
